(19) United States
(12) Patent Application Publication
(10) Pub. No.: US 2015/0074598 A1
(43) Pub. Date: Mar. 12, 2015

(54) INFORMATION PROCESSING METHODS AND ELECTRONIC DEVICES

(71) Applicant: Lenovo (Beijing) Limited, Beijing (CN)

(72) Inventors: Yingjia Yao, Beijing (CN); Xiaoting Shao, Beijing (CN); Yong Chen, Beijing (CN)

(73) Assignee: Lenovo (Beijing) Limited, Beijing (CN)

(21) Appl. No.: 14/230,744

(22) Filed: Mar. 31, 2014

(30) Foreign Application Priority Data
Sep. 9, 2013 (CN) 201310407356.2
Sep. 9, 2013 (CN) 201310407544.5

(51) Int. Cl. G06F 3/0484

(52) U.S. Cl. CPC G06F 3/0484
USPC 715/803

(57) ABSTRACT

The present invention discloses an information processing method and an electronic device, the method applied in the electronic device, the electronic device having a display screen and at least a first operation mode and a second operation mode different from the first operation mode, the method comprising: when the electronic device is in the first operation mode, displaying a first image in a first size on a first display area of the display screen, and detecting whether a first operation of switching an operation mode of the electronic device from the first operation mode to the second operation mode is obtained; when the first operation is obtained, switching the operation mode of the electronic device from the first operation mode to the second operation mode in response to the first operation, and displaying a second image on the display screen; the display screen has a first display area in the second operation mode and a second display area in the second operation mode, first sub display content in the second operation mode is displayed, and second sub display content in the second operation mode is displayed.

### TECHNICAL FIELD

The present disclosure relates to a field of information processing techniques, and particularly, to an information processing method and an electronic device.

### BACKGROUND

With rapid development of science and technology, functions of an electronic device are becoming richer and richer. A user may do more and more things by the electronic device, such as watching movies, browsing web pages, reading e-books etc.

Since there are generally various operation modes of the electronic device, different functions of the electronic device may be adapted to be used in different operation modes. For example, a function of browsing web pages is adapted to be used in a horizontal screen usage mode of a tablet computer, while a function of reading e-books is adapted to be used in a vertical screen usage mode of the tablet computer. When the user uses different functions of the electronic device, it is required to switch between different operation modes for better user experience.

However, the inventor of the present application found at least technical problems as follows during implementation of technical solutions in embodiments of the present application.

During the operation mode of the electronic device is being switched, no display content corresponding to the switched operation mode is displayed on a display screen of the electronic device. When the user wants to use the function in the appropriately switched operation mode, he may use the corresponding function only if he must open an application management interface and click a corresponding application icon. Therefore, there are one or more non-continuous time points in a whole procedure of responding to the function operation, which causes a slow running rate of the electronic device. There is a technical problem of being not able to display, on the display screen of the electronic device, the display content corresponding to the switched operation mode during the operation mode of the electronic device is being switched. Thus, the user's comfort degree of using the electronic device may be significantly reduced.

### SUMMARY OF INVENTION

The present application provides an information processing method and an electronic device for solving the technical problem of being not able to display, on the display screen of the electronic device, the display content corresponding to the switched operation mode during the operation mode of the electronic device is being switched, achieving a technical effect of displaying, on the display screen of the electronic device, the display content corresponding to the switched operation mode during the operation mode of the electronic device is being switched. Thus, the user's comfort degree of using the electronic device may be significantly improved.

An aspect in an embodiment of the present application provides an information processing method applied in an electronic device, the electronic device having a display screen and at least a first operation mode and a second operation mode different from the first operation mode, the method comprising:

when the electronic device is in the first operation mode, displaying a first image in a first size on a first display area of the display screen, and detecting whether a first operation of switching an operation mode of the electronic device from the first operation mode to the second operation mode is obtained;

when the first operation is obtained, switching the operation mode of the electronic device from the first operation mode to the second operation mode in response to the first operation, and displaying a second image on the display screen, the second image being different from the first image;

wherein when the electronic device is in the second operation mode, the display screen has a first display area in the second operation mode and a second display area in the second operation mode, first sub display content in the second operation mode is displayed on the first display area in the second operation mode, and second sub display content in the second operation mode is displayed on the second display area in the second operation mode; and

wherein the first display area in the second operation mode is different from the second display area in the second operation mode, the first display sub-content in the second operation mode is different from the second display sub-content in the second operation mode, and the first display sub-content in the second operation mode is display content corresponding to the second operation mode.

Alternatively, the second sub display content in the second operation mode is the first image.

Alternatively, a second relative position relationship between the first display area in the second operation mode and the second display area in the second operation mode is: not-overlapped with each other, or partly overlapped with each other; or

completely overlapped where the second display area in the second operation mode belongs to a part of the first display area in the second operation mode.

Alternatively, the first display area in the second operation mode has a first size in the second operation mode, and the second display area in the second operation mode has a second size in the second operation mode, the first size in the second operation mode being different from the second size in the second operation mode.

Alternatively, the first image is particularly: an image of a main interface of the electronic device; or

an image of a first main interface corresponding to the first operation mode; or

an image consisting of the second sub display content in the first operation mode and the first sub display content in the first operation mode corresponding to the first operation mode; or

a first run image of a first application running in the electronic device, when the electronic device is in the first operation mode.

Alternatively, when the display screen is a touch display screen, after the second sub display content in the second operation mode displayed on the second display area in the second operation mode of the display screen, the method further comprises:

judging whether a click operation on the first display area in the second operation mode is obtained on the touch display screen, before counted time of a timer in the electronic device reaches a predetermined value;

closing the first display area in the second operation mode, when the click operation is not obtained on the touch display screen.

Alternatively, after it is judged whether the click operation on the first display area in the second operation mode is obtained on the touch display screen before the counted time of the timer in the electronic device reaches the predetermined value, the method further comprises:

closing the second display area in the second operation mode, when the click operation is obtained on the touch display screen;

wherein the first sub display content in the second operation mode is displayed in a direction from a first side of the touch display screen to a second side of the touch display screen opposite to the first side between a first instant and a second instant later than the first instant, and the touch display screen is fully filled with the first sub display content in the second operation mode at the second instant.

Alternatively, after the operation mode of the electronic device is switched from the first operation mode to the second operation mode in response to the first operation when the first operation is obtained, the method further comprises:

detecting whether a second operation of switching the operation mode of the electronic device from the second operation mode to the first operation mode is obtained;

switching the operation mode of the electronic device from the second operation mode to the first operation mode in response to the second operation, when the second operation is obtained;

when the electronic device is in the first operation mode, the display screen has the first display area in the first operation mode and a second display area in the first operation mode, first sub display content in the first operation mode is displayed on the first display area in the first operation mode, and second sub display content in the first operation mode is displayed on the second display area in the first operation mode; and

wherein the first display area in the first operation mode is different from the second display area in the first operation mode, the first display sub-content in the first operation mode is different from the second display sub-content in the first operation mode, and the first display sub-content in the first operation mode is display content corresponding to the first operation mode.

Alternatively, the second sub display content in the first operation mode is the second image.

Alternatively, a first relative position relationship between the first display area in the first operation mode and the second display area in the first operation mode is: not-overlapped with each other, or partly overlapped with each other; or

completely overlapped where the second display area in the first operation mode belongs to a part of the first display area in the first operation mode.

Alternatively, the first display area in the first operation mode has a first size in the first operation mode, and the second display area in the first operation mode has a second size in the first operation mode, the first size in the first operation mode being different from the second size in the first operation mode.

Alternatively, any two of the first display area in the first operation mode, the first display area in the second operation mode, and the second display area on the second operation mode are different; and

any two of the second display area in the first operation mode, the first display area in the second operation mode, and the second display area on the second operation mode are different.

Alternatively, the electronic device has a first device pattern and a second device pattern, the first device pattern being different from the second device pattern.

Alternatively, when the first device pattern is particularly a tablet computer pattern, the first operation mode is particularly a horizontal screen usage mode, and the second operation mode is particularly a vertical screen usage mode;

switching the operation mode of the electronic device from the first operation mode to the second operation mode particularly comprises:

obtaining a first included angle of the electronic device relative to a preset plane at the first instant and when the electronic device is in the horizontal screen usage mode, wherein the first included angle is within a first included angle scope corresponding to the horizontal screen usage mode;

obtaining a second included angle of the electronic device relative to the preset plane at the second instant later than the first instant; and

switching the electronic device from the horizontal screen usage mode to the vertical screen usage mode, when the first included angle is different from the second included angle and the second included angle is within a second included angle scope corresponding to the vertical screen usage mode.

Alternatively, when the display screen is in the vertical screen usage mode, at least one first type icon corresponding to at least one first type application matched with the vertical screen usage mode is displayed on the first display area in the vertical screen usage mode of the display screen.

Alternatively, when the display screen is in the horizontal screen usage mode, at least one second type icon corresponding to at least one second type application matched with the horizontal screen usage mode is displayed on the first display area in the horizontal screen usage mode of the display screen.

Alternatively, when the electronic device is in a multi-modality electronic device pattern, the electronic device has a first body and a second body which are relatively rotatably connected via a shaft, a second face of the first body is provided with the display screen, a third face of the second body is provided with an input apparatus, the first operation mode is particularly one of a stand mode, a notebook mode, a tent mode and a tablet mode;

the second operation mode is particularly one of the stand mode, the notebook mode, the tent mode and the tablet mode, the second operation mode being different from the first operation mode;

switching the operation mode of the electronic device from the first operation mode to the second operation mode particularly comprises:

obtaining a third included angle between the first body and the second body at the first instant and when the first operation mode is one of the stand mode, the notebook mode, the tent mode and the tablet mode owned by the electronic device, in which the third included angle is within a third included angle scope corresponding to the first operation mode;

obtaining a fourth included angle between the first body and the second body at the second instant later than the first instant; and

switching the electronic device from the first operation mode to another operation mode which is the second operation mode, when the fourth included angle is different from the third included angle and the fourth included angle is within a fourth included angle scope corresponding to another mode of the stand mode, the notebook mode, the tent mode and the tablet mode.

Another aspect in an embodiment of the present application provides an electronic device, comprising:

a first detection unit, configured for, when the electronic device is in the first operation mode, displaying a first image in a first size on a first display area of the display screen, and detecting whether a first operation of switching an operation mode of the electronic device from the first operation mode to the second operation mode is obtained;

a first response unit, configured for, when the first operation is obtained, switching the operation mode of the electronic device from the first operation mode to the second operation mode in response to the first operation, and displaying a second image on the display screen, the second image being different from the first image;

wherein when the electronic device is in the second operation mode, the display screen has a first display area in the second operation mode and a second display area in the second operation mode, first sub display content in the second operation mode is displayed on the first display area in the second operation mode, and second sub display content in the second operation mode is displayed on the second display area in the second operation mode; and

wherein the first display area in the second operation mode is different from the second display area in the second operation mode, the first display sub-content in the second operation mode is different from the second display sub-content in the second operation mode, and the first display sub-content in the second operation mode is display content corresponding to the second operation mode.

Alternatively, the second sub display content in the second operation mode is the first image.

Alternatively, a second relative position relationship between the first display area in the second operation mode and the second display area in the second operation mode is: not-overlapped with each other, or partly overlapped with each other; or

completely overlapped where the second display area in the second operation mode belongs to a part of the first display area in the second operation mode.

Alternatively, the first display area in the second operation mode has a first size in the second operation mode, and the second display area in the second operation mode has a second size in the second operation mode, the first size in the second operation mode being different from the second size in the second operation mode.

Alternatively, the second size in the second operation mode is less than the first size in the second operation mode.

Alternatively, the first image is particularly:

an image of a main interface of the electronic device; or

an image of a first main interface corresponding to the first operation mode; or

an image consisting of the second sub display content in the first operation mode and the first sub display content in the first operation mode corresponding to the first operation mode; or

a first run image of a first application running in the electronic device, when the electronic device is in the first operation mode.

Alternatively, the electronic device further comprises:

a first judging unit, configured for, judging whether a click operation on the first display area in the second operation mode is obtained on the touch display screen, before counted time of a timer in the electronic device reaches a predetermined value;

a first control unit, configure for closing the first display area in the second operation mode, when the click operation is not obtained on the touch display screen.

Alternatively, the electronic device further comprises:

a second control unit, configured for closing the second display area in the second operation mode, when the click operation is obtained on the touch display screen;

wherein the first sub display content in the second operation mode is displayed in a direction from a first side of the touch display screen to a second side of the touch display screen opposite to the first side between a first instant and a second instant later than the first instant, and the touch display screen is fully filled with the first sub display content in the second operation mode at the second instant.

Alternatively, the electronic device further comprises:

a second detection unit, configured for detecting whether a second operation of switching the operation mode of the electronic device from the second operation mode to the first operation mode is obtained;

a second response unit, configured for switching the operation mode of the electronic device from the second operation mode to the first operation mode in response to the second operation, when the second operation is obtained;

when the electronic device is in the first operation mode, the display screen has the first display area in the first operation mode and a second display area in the first operation mode, first sub display content in the first operation mode is displayed on the first display area in the first operation mode, and second sub display content in the first operation mode is displayed on the second display area in the first operation mode; and

wherein the first display area in the first operation mode is different from the second display area in the first operation mode, the first display sub-content in the first operation mode is different from the second display sub-content in the first operation mode, and the first display sub-content in the first operation mode is display content corresponding to the first operation mode.

Alternatively, the second sub display content in the first operation mode is the second image.

Alternatively, a first relative position relationship between the first display area in the first operation mode and the second display area in the first operation mode is: not-overlapped with each other, or partly overlapped with each other, or

completely overlapped where the second display area in the first operation mode belongs to a part of the first display area in the first operation mode.

Alternatively, the first display area in the first operation mode has a first size in the first operation mode, and the second display area in the first operation mode has a second size in the first operation mode, the first size in the first operation mode being different from the second size in the first operation mode.

Alternatively, any two of the first display area in the first operation mode, the first display area in the second operation mode, and the second display area on the second operation mode are different; and

any two of the second display area in the first operation mode, the first display area in the second operation mode, and the second display area on the second operation mode are different.

Alternatively, the electronic device has a first device pattern and a second device pattern, the first device pattern being different from the second device pattern.

Alternatively, when the first device pattern is particularly a tablet computer pattern, the first operation mode is particularly a horizontal screen usage mode, and the second operation mode is particularly a vertical screen usage mode;

switching the operation mode of the electronic device from the first operation mode to the second operation mode particularly comprises:

obtaining a first included angle of the electronic device relative to a preset plane at the first instant and when the electronic device is in the horizontal screen usage mode, wherein the first included angle is within a first included angle scope corresponding to the horizontal screen usage mode;

obtaining a second included angle of the electronic device relative to the preset plane at the second instant later than the first instant; and

switching the electronic device from the horizontal screen usage mode to the vertical screen usage mode, when the first included angle is different from the second included angle and the second included angle is within a second included angle scope corresponding to the vertical screen usage mode.

Alternatively, when the display screen is in the vertical screen usage mode, at least one first type icon corresponding to at least one first type application matched with the vertical screen usage mode is displayed on the first display area in the vertical screen usage mode of the display screen.

Alternatively, when the display screen is in the horizontal screen usage mode, at least one second type icon corresponding to at least one second type application matched with the horizontal screen usage mode is displayed on the first display area in the horizontal screen usage mode of the display screen.

Alternatively, when the electronic device is in a multi-modality electronic device pattern, the electronic device has a first body and a second body which are relatively rotatably connected via a shaft, a second face of the first body is provided with the display screen, a third face of the second body is provided with an input apparatus, the first operation mode is particularly one of a stand mode, a notebook mode, a tent mode and a tablet mode;

the second operation mode is particularly one of the stand mode, the notebook mode, the tent mode and the tablet mode, the second operation mode being different from the first operation mode;

switching the operation mode of the electronic device from the first operation mode to the second operation mode particularly comprises:

obtaining a third included angle between the first body and the second body at the first instant and when the first operation mode is one of the stand mode, the notebook mode, the tent mode and the tablet mode owned by the electronic device, in which the third included angle is within a third included angle scope corresponding to the first operation mode;

obtaining a fourth included angle between the first body and the second body at the second instant later than the first instant; and

switching the electronic device from the first operation mode to another operation mode which is the second operation mode, when the fourth included angle is different from the third included angle and the fourth included angle is within a fourth included angle scope corresponding to another mode of the stand mode, the notebook mode, the tent mode and the tablet mode.

One or more technical solutions provided in the embodiments of the present application have at least technical effects or advantages as follows.

1. In the present application, during the operation mode of the electronic device is switched from the first operation mode to the second operation mode, the second sub display content in the second operation mode is displayed on the second display area in the second operation mode, while the first sub display content in the second operation mode is displayed on the first display area in the second operation mode of the display screen in the electronic device; and the first display sub-content in the second operation mode is the display content corresponding to the second operation mode.

For example, assuming that the electronic device is the tablet computer, during the operation mode of the tablet computer is switched from the horizontal screen usage mode to the vertical screen usage mode, at least one first type icon, e.g., an icon for reading the e-book corresponding to at least one first type application matched with the vertical screen usage mode may be displayed in a long side area on the display screen in the electronic device; and simultaneously, the first sub display content, e.g., the image previously displayed on the display screen before the operation mode is switched, in the vertical screen usage mode is displayed in any of areas in the display screen.

Therefore, the technical solution of the embodiments of the present application may effectively solve the technical problem of being not able to display, on the display screen of the electronic device, the display content corresponding to the switched operation mode during the operation mode of the electronic device is being switched, and achieve the technical effect of displaying, on the display screen of the electronic device, the display content corresponding to the switched operation mode during the operation mode of the electronic device is being switched. Thus, the user's comfort degree of using the electronic device may be significantly improved.

2. When the electronic device is the tablet computer, the horizontal screen usage mode and the vertical screen usage mode of the tablet computer may be switched mutually, and during the switching, the display content corresponding to the current operation mode may be displayed. For example, after the tablet computer is switched from the horizontal screen usage mode to the vertical screen usage mode, the display content corresponding to the vertical screen usage mode, e.g., the icon corresponding to the e-book application, may be displayed; and after the tablet computer is switched from the vertical screen usage mode to the horizontal screen usage mode, the display content corresponding to the horizontal screen usage mode, e.g., an icon corresponding to web-page browsing, may be displayed. Since the display content corresponding to the current operation mode may be displayed after the operation mode is switched, the corresponding icon may be clicked conveniently and rapidly, and then the corresponding function may be used, the user experience degree may be improved.

3. When the electronic device is a multi-modality electronic device, the four modes of the multi-modality electronic device, i.e., the stand mode, the notebook mode, the tent mode and the tablet mode, may be switched mutually, and during the switching, the display content corresponding to the current operation mode may be displayed. For example, the display content corresponding to the tent mode, e.g., an icon corresponding to an video playing application, may be displayed after the electronic device is switched from the stand mode to the tent mode; the display content corresponding to the stand mode, e.g., an icon corresponding to a picture viewing application, may be displayed after the electronic device is switched from the tent mode to the stand mode. Since the display content corresponding to the current operation mode may be displayed after the operation mode is switched, the corresponding icon may be clicked conveniently and rapidly, and then the corresponding function may be used, the user experience degree may be improved.

4. Since the timer in the electronic device is used for time counting, it may be detected whether the user clicks the display content corresponding to the current operation mode, before the counted time reaches the predetermined value. If the display content corresponding to the current operation mode is clicked, the display content may be displayed from one side of the display screen to fully fill the whole display screen, if the display content corresponding to the current operation mode is not clicked, the display content may be closed. Therefore, the user may be provided with a convenient and rapid selection of opening the application corresponding to the current operation mode, and since the whole display screen is fully filled with the display content corresponding to the current operation mode, the user may select from a plurality of applications corresponding to the current operation mode, which improves the user experience.

Additionally, the embodiments of the present application provide a display method and an electronic device for solving a technical problem of inconvenient operations on the electronic device.

A display method, applied in an electronic device having a display unit, the method comprising:

obtaining first operation information for the electronic device;

displaying a side column by the display unit according to the first operation information, the side column including at least a first part and a second part; wherein the first part is used for prompting a current usage mode of the electronic device to a user, and the second part comprises at least one interactive object.

Preferably, obtaining first operation information for the electronic device comprises: obtaining the first operation information for changing the usage mode of the electronic device; or obtaining the first operation information indicating that a specific key of the electronic device is pressed; or obtaining the first operation information indicating sliding in the display unit.

Preferably, when the first operation information indicating sliding in the display unit is obtained, displaying the side column by the display unit according to the first operation information comprises:

determining a first operation track corresponding to the first operation information; and

controlling an edge of the side column to be unfolded along a movement direction of the first operation track in the display unit.

Preferably, after the side column is displayed by the display unit according to the first operation information, the method further comprises:

obtaining second operation information for a first interactive object; and

displaying a first display window corresponding to the first interactive object by the display unit, and forbidding displaying the side column.

Preferably, after the side column is displayed by the display unit according to the first operation information, the method further comprises:

obtaining third operation information for the electronic device; and

forbidding displaying the side column according to the third operation information.

Preferably, when the third operation information is the operation information indicating sliding in the display unit, forbidding displaying the side column according to the third operation information comprises:

determining a third operation track corresponding to the third operation information; and

controlling an edge of the side column to be folded along a movement direction of the third operation track in the display unit.

Preferably, when the current usage modes of the electronic device are different, the interactive objects are different.

An electronic device having a display unit further comprises:

an obtaining module, configured for obtaining first operation information for the electronic device;

an operation module, configured for displaying a side column by the display unit according to the first operation information, the side column including at least a first part and a second part; wherein the first part is used for prompting a current usage mode of the electronic device to a user, and the second part comprises at least one interactive object.

Preferably, the obtaining module is particularly configured for obtaining the first operation information for changing the usage mode of the electronic device; or obtaining the first operation information indicating that a specific key of the electronic device is pressed; or obtaining the first operation information indicating sliding in the display unit.

Preferably, when the first operation information indicating sliding in the display unit is obtained, the operation module is particularly configured for determining a first operation track corresponding to the first operation information; and controlling an edge of the side column to be unfolded along a movement direction of the first operation track in the display unit.

Preferably, the obtaining module is further configured for obtaining second operation information for a first interactive object;

the operation module is further configured for displaying a first display window corresponding to the first interactive object by the display unit, and forbidding displaying the side column.

Preferably, the obtaining module is further configured for obtaining third operation information for the electronic device;

the operation module is further configured for forbidding displaying the side column according to the third operation information.

Preferably, when the third operation information is the operation information indicating sliding in the display unit, the operation module is particularly configured for determining a third operation track corresponding to the third operation information, and controlling an edge of the side column to be folded along a movement direction of the third operation track in the display unit.

Preferably, when the current usage modes of the electronic device are different, the interactive objects are different.

The embodiment of the present application provides a display method applied in the electronic device having the display unit. The method may comprise: obtaining first operation information for the electronic device; displaying a side column by the display unit according to the first operation information, the side column including at least a first part and a second part; wherein the first part is used for prompting a current usage mode of the electronic device to a user, and the second part comprises at least one interactive object.

In the embodiment of the present application, after the electronic device obtains the first operation information, the side column may be displayed. The side column is obviously located at the side of the display unit. The user may operate on the interactive object in the side column even if he holds the electronic device by a single hand, and won't be unable to click the interactive object due to a longer distance. Thus, convenience of operations on the electronic device may be significantly improved.

### BRIEF DESCRIPTION OF THE DRAWINGS

FIG. 1 shows a flowchart of an information processing method according to an embodiment of the present application;

FIG. 2A shows a horizontal screen usage mode of an electronic device whose device pattern is a tablet computer according to an embodiment of the present application;

FIG. 2B shows a vertical screen usage mode of an electronic device whose device pattern is a tablet computer according to an embodiment of the present application;

FIG. 3A shows a stand mode of an electronic device which is a multi-modality electronic device according to an embodiment of the present application;

FIG. 3B shows a tent mode of an electronic device which is a multi-modality electronic device according to an embodiment of the present application;

FIG. 3C shows a tablet mode of an electronic device which is a multi-modality electronic device according to an embodiment of the present application;

FIG. 3D shows a notebook mode of an electronic device which is a multi-modality electronic device according to an embodiment of the present application;

FIG. 4 shows a module diagram of an electronic device according to an embodiment of the present application;

FIG. 5 shows a main flowchart of a display method according to an embodiment of the present application;

FIGS. 6A-6B show usage mode schematic diagrams of an electronic device according to an embodiment of the present application;

FIGS. 7A-7B show display schematic diagrams of a side column according to an embodiment of the present application; and

FIG. 8 shows a structure diagram of an electronic device according to an embodiment of the present application.

### DETAILED DESCRIPTION

The present application provides an information processing method and an electronic device for solving the technical problem of being not able to display, on the display screen of the electronic device, the display content corresponding to the switched operation mode during the operation mode of the electronic device is being switched, achieving a technical effect of displaying, on the display screen of the electronic device, the display content corresponding to the switched operation mode during the operation mode of the electronic device is being switched. Thus, the users comfort degree of using the electronic device may be significantly improved.

A general concept of technical solutions in the embodiments of the present application for solving the above technical problem may be illustrated as follows.

firstly, when the electronic device is in the first operation mode, displaying a first image in a first size on a first display area of the display screen, and detecting whether a first operation of switching an operation mode of the electronic device from the first operation mode to the second operation mode is obtained;

secondly, when the first operation is obtained, switching the operation mode of the electronic device from the first operation mode to the second operation mode in response to the first operation, and displaying a second image on the display screen, the second image being different from the first image; wherein when the electronic device is in the second operation mode, the display screen has a first display area in the second operation mode and a second display area in the second operation mode, first sub display content in the second operation mode is displayed on the first display area in the second operation mode, and second sub display content in the second operation mode is displayed on the second display area in the second operation mode; and wherein the first display sub-content in the second operation mode is display content corresponding to the second operation mode.

Therefore, the embodiments of the present application may solve a technical problem of not being able to display the display content for prompting the user that a plurality of functions in the electronic device may be used, and achieve a technical effect of displaying the display content for prompting the user that the plurality of functions in the electronic device may be used while the display content corresponding to the switched operation mode is displayed. Thus, the user's comfort degree of using the electronic device may be significantly improved.

Hereinafter, the technical solutions of the present disclosure will be described in detail in connection with the drawings and particular embodiments. It should be understood that the embodiments of the present disclosure and the specific features in the embodiments are detailed illustration for the technical solutions of the present disclosure, but not limitations thereon. The embodiments of the present disclosure and the specific features in the embodiments may be combined mutually in a case of no confliction.

### Embodiment One

In Embodiment One, an information processing method may be provided, the method applied in an electronic device, the electronic device having a display screen and at least a first operation mode and a second operation mode different from the first operation mode. In a specific implementation, the electronic device may be a tablet computer or a smart phone or a notebook computer, which are only examples but not any limitations here.

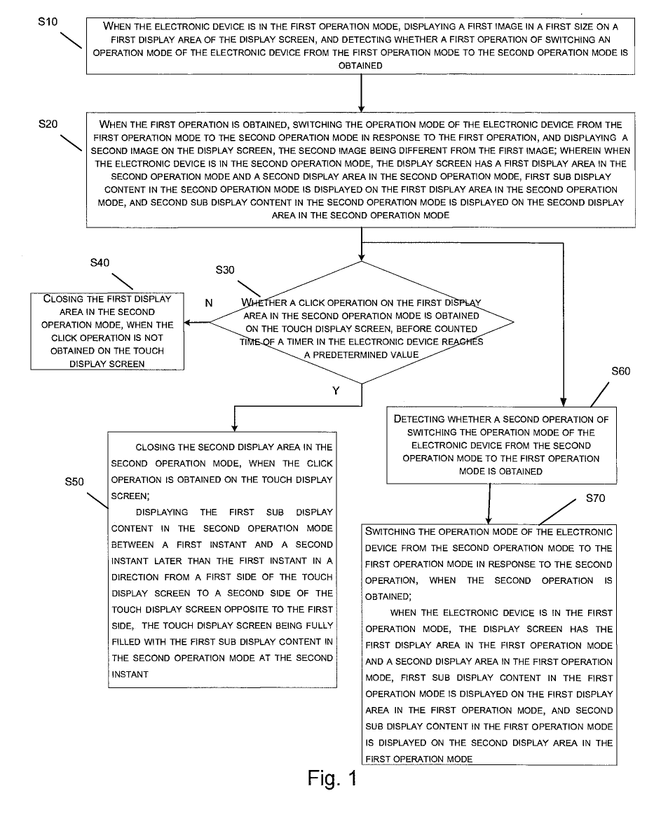

Hereinafter, the particular implementation of the information processing method and the particular operation principle of the electronic device in Embodiment One will be described in detail in connection with FIG. 1.

The information processing method in Embodiment One may comprise:

Step S10 of, when the electronic device is in the first operation mode, displaying a first image in a first size on a first display area of the display screen, and detecting whether a first operation of switching an operation mode of the electronic device from the first operation mode to the second operation mode is obtained;

Step S20 of, when the first operation is obtained, switching the operation mode of the electronic device from the first operation mode to the second operation mode in response to the first operation, and displaying a second image on the display screen, the second image being different from the first image;

wherein when the electronic device is in the second operation mode, the display screen has a first display area in the second operation mode and a second display area in the second operation mode, first sub display content in the second operation mode is displayed on the first display area in the second operation mode, and second sub display content in the second operation mode is displayed on the second display area in the second operation mode; and

wherein the first display area in the second operation mode is different from the second display area in the second operation mode, the first display sub-content in the second operation mode is different from the second display sub-content in the second operation mode, and the first display sub-content in the second operation mode is display content corresponding to the second operation mode.

After step S20, the information processing method in the embodiment of the present application proceeds to step S30, i.e., judging whether a click operation on the first display area in the second operation mode is obtained on the touch display screen, before counted time of a timer in the electronic device reaches a predetermined value.

After step S30, the information processing method in the embodiment of the present application proceeds to steps S40 and S50, i.e.,

Step S40 of closing the first display area in the second operation mode, when the click operation is not obtained on the touch display screen.

Step S50 of closing the second display area in the second operation mode, when the click operation is obtained on the touch display screen.

In the method according to the embodiment of the present application, between a first instant and a second instant later than the first instant, in order to select among a plurality of application icons in the display content corresponding to the current operation mode, the method may further comprise: displaying the first sub display content in the second operation mode in a direction from a first side of the touch display screen to a second side of the touch display screen opposite to the first side, the touch display screen being fully filled with the first sub display content in the second operation mode at the second instant.

In the embodiment of the present application, the electronic device has a first device pattern and a second device pattern, the first device pattern being different from the second device pattern.

Further, the second sub display content in the second operation mode is the first image.

Still further, the first image is particularly an image of a main interface of the electronic device; or an image of a first main interface corresponding to the first operation mode; or an image consisting of the second sub display content in the first operation mode and the first sub display content in the first operation mode corresponding to the first operation mode; or a first run image of a first application running in the electronic device, when the electronic device is in the first operation mode.

In a specific implementation of the method in the embodiment of the present application, since the device patterns of the electronic device are different, or the first images are different, the specific implementations of steps S10-S50 are also different. Hereinafter, the specific implementations of steps S10-S50 will be described in detail for different application scenes of the embodiment of the present application.

The method in the embodiment of the present application may be applied in the electronic device. The electronic device may be a pad-type electronic device, a tablet computer, a smart phone or a multimedia playing device. The pad-type electronic device does not change the pattern of a body of the pad-type electronic device due to variation of its operation mode. For example, the pattern of the pad-type electronic device is always pad-type regardless of a horizontal screen operation mode or a vertical screen operation mode that the pad-type electronic device is in.

The method according to the embodiment of the present application may be applied in the multi-modality electronic device. The multi-modality electronic device may comprise an entity structure, which can connect two bodies of the multi-modality electronic device, for implementing a relative rotation and/or a relative separation of the two bodies of the multi-modality electronic device, so that the multi-modality electronic device may be switched between a plurality of different operation modes. The plurality of different operation patterns of the multi-modality electronic device may form the different usage modes of the multi-modality electronic device which is constituted by the two bodies by the entity structure. For example, the two bodies may be relatively rotated by 360° by means of the shaft, so that switching between at least the notebook operation mode/usage mode (rotated by 90-180°) and the tablet computer operation mode/usage mode (rotated by 360°) may be implemented; separation and connection of the two bodies may be implemented by a plug-pull structure, wherein the electronic device is in the notebook operation mode/usage mode when the two bodies are connected; and the electronic device is in the tablet computer operation mode/usage mode when the two bodies are separated. For example, the first body may be the tablet computer, the second body may be a device with at least an input unit, which may be a cover of the tablet computer or an electronic device (i.e., a computer without the display unit, or the tablet computer etc.).

Additionally, the entity structure may be a supporting structure. When the supporting structure unfolds a certain angle relative to the body of the multi-modality electronic device and supports on a bearing surface together with the body of the multi-modality electronic device, the multi-modality electronic device may be in an all-in-one computer operation mode/usage mode; when the supporting structure folds relative to the multi-modality electronic device, the multi-modality electronic device may be in the tablet computer operation mode/usage mode.

Application Scene One

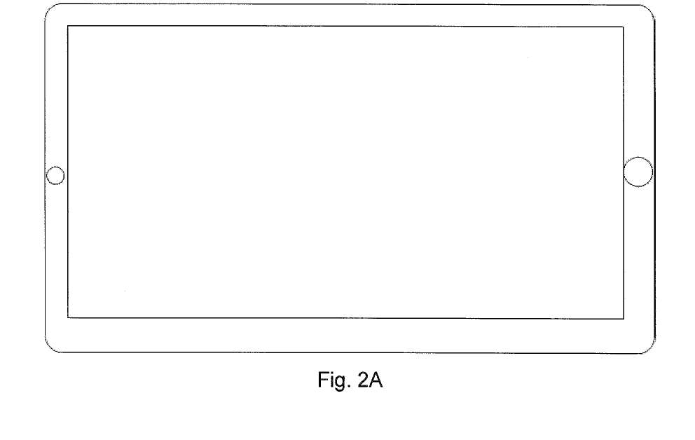

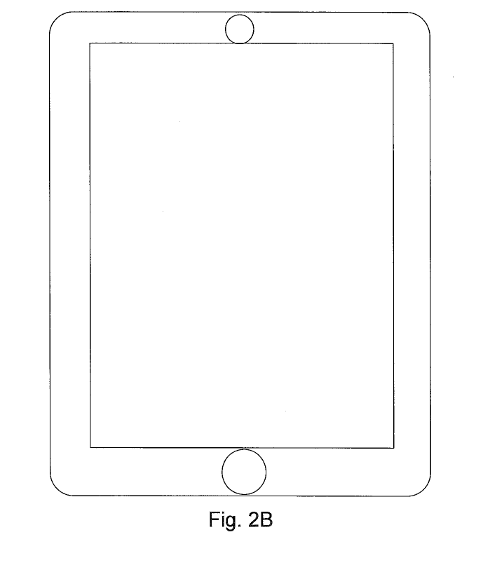

Assuming that the pattern of the electronic device is the tablet computer, the first image is the main interface image of the tablet computer; and the first operation mode is the horizontal screen usage mode, as shown in FIG. 2A, and the second operation mode is the vertical screen usage mode, as shown in FIG. 2B. A specific implementation of the steps S10-S50 in the embodiment of the present application may be described as follows.

When the tablet computer is in the horizontal screen usage mode, the main interface image may be displayed in the first size on the first display area of the display screen, and it may be detected whether the first operation of switching the operation mode of the tablet computer from the horizontal screen usage mode to the vertical screen usage mode is obtained, wherein the first display area is any of areas on the display screen, and the first size is no more than the size of the display screen.

The particular detection approach is: detecting whether a change occurs on an included angle of the tablet computer relative to a first preset plane (e.g., ground). Since a gravity sensor may calculate an inclination angle of the electronic device relative to the horizontal plane by measuring variation of an acceleration caused by the gravity, it may be detected by the gravity sensor whether there is a change occurring on the included angle of the electronic device relative to the ground. In particular, a first angle value of the included angle of the tablet computer relative to the ground, e.g., 0°, may be firstly obtained, then a second angle value of the included angle of the tablet computer relative to the ground may be obtained. If the obtained second angle value of the included angle of the tablet computer relative to the ground is 10°, it indicates that the first operation of switching the operation mode of the tablet computer from the horizontal screen usage mode to the vertical screen usage mode is obtained; and if the obtained second angle value of the included angle of the tablet computer relative to the ground is 0°, it indicates that the first operation of switching the operation mode of the tablet computer from the horizontal screen usage mode to the vertical screen usage mode is not obtained.

When the first operation of switching the operation mode of the tablet computer from the horizontal screen usage mode to the vertical screen usage mode is obtained, the operation mode of the tablet computer may be switched from the horizontal screen usage mode to the vertical screen usage mode in response to the first operation, and the second image may be displayed on the display screen.

When the tablet computer is in the vertical screen usage mode, the display screen has the first display area in the vertical screen usage mode and the second display area in the vertical screen usage mode, in which the first display area in the vertical screen usage mode is a long side area of the display screen, and the second display area in the vertical screen usage mode is any of areas on the display screen.

The first sub display content in the vertical screen usage mode, i.e., the display content corresponding to the vertical screen usage mode (such as a function adapted to be used in the vertical screen mode, an e-book reading application icon, an instant communication application icon), may be displayed on the long side area of the display screen. Simultaneously, the first image, i.e., the main interface of the tablet computer, may be displayed in any of areas on the display screen.

It may be judged whether a click operation on the long side area of the display screen is obtained on the touch display screen before the counted time of the timer in the tablet computer reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the main interface image of the tablet computer to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the e-book reading function adapted to the current vertical screen usage mode, the display content corresponding to the vertical screen usage mode may be displayed started from the long side area of the display screen, until the touch display screen is fully filled with the display content corresponding to the vertical screen usage mode, i.e., the display content corresponding to the vertical screen usage mode may be zoomed-in to the full screen from the long side area, so that the user may select, from the display content corresponding to the vertical screen usage mode, the function needed to be used.

Application Scene Two

Assuming that the pattern of the electronic device is the tablet computer, the first image is a first run image of a first application running in the tablet computer when the tablet computer is in the horizontal screen usage mode, i.e., the image run by a wordpad application running in the tablet computer; and the first operation mode is the horizontal screen usage mode, and the second operation mode is the vertical screen usage mode. A specific implementation of the steps S10-S50 in the embodiment of the present application may be described as follows.

When the tablet computer is in the horizontal screen usage mode, the image run by the wordpad application may be displayed in the first size on the first display area of the display screen, and it may be detected whether the first operation of switching the operation mode of the tablet computer from the horizontal screen usage mode to the vertical screen usage mode is obtained, wherein the first display area is any of areas on the display screen, and the first size is no more than the size of the display screen.

The particular detection approach is: detecting whether a change occurs on an included angle of the tablet computer relative to a first preset plane (e.g., ground). Since a gravity sensor may calculate an inclination angle of the electronic device relative to the horizontal plane by measuring variation of an acceleration caused by the gravity, it may be detected by the gravity sensor whether there is a change occurring on the included angle of the electronic device relative to the ground. In particular, a first angle value of the included angle of the tablet computer relative to the ground, e.g., 0°, may be firstly obtained, then a second angle value of the included angle of the tablet computer relative to the ground may be obtained. If the obtained second angle value of the included angle of the tablet computer relative to the ground is 10°, it indicates that the first operation of switching the operation mode of the tablet computer from the horizontal screen usage mode to the vertical screen usage mode is obtained; and if the obtained second angle value of the included angle of the tablet computer relative to the ground is 0°, it indicates that the first operation of switching the operation mode of the tablet computer from the horizontal screen usage mode to the vertical screen usage mode is not obtained.

When the first operation of switching the operation mode of the tablet computer from the horizontal screen usage mode to the vertical screen usage mode is obtained, the operation mode of the tablet computer may be switched from the horizontal screen usage mode to the vertical screen usage mode in response to the first operation, and the second image may be displayed on the display screen.

When the tablet computer is in the vertical screen usage mode, the display screen has the first display area in the vertical screen usage mode and the second display area in the vertical screen usage mode, in which the first display area in the vertical screen usage mode is a long side area of the display screen, and the second display area in the vertical screen usage mode is any of areas on the display screen.

The first sub display content in the vertical screen usage mode, i.e., the display content corresponding to the vertical screen usage mode (such as a function adapted to be used in the vertical screen mode, an e-book reading application icon, an instant communication application icon), may be displayed on the long side area of the display screen. Simultaneously, the first image, i.e., the main interface of the tablet computer, may be displayed in any of areas on the display screen.

It may be judged whether a click operation on the long side area of the display screen is obtained on the touch display screen before the counted time of the timer in the tablet computer reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the first run image of the first application running in the tablet computer, e.g. the image run by the wordpad application running in the tablet computer, to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the e-book reading function adapted to the current vertical screen usage mode, the display content corresponding to the vertical screen usage mode may be displayed started from the long side area of the display screen, until the touch display screen is fully filled with the display content corresponding to the vertical screen usage mode, i.e., the display content corresponding to the vertical screen usage mode may be zoomed-in to the full screen from the long side area, so that the user may select, from the display content corresponding to the vertical screen usage mode, the function needed to be used.

Application Scene Three

Assuming that the pattern of the electronic device is the tablet computer, the first image is the second image in the horizontal screen usage mode and the image constituted by the display content corresponding to the horizontal screen usage mode, e.g., the image displayed on the display screen after the tablet computer is switched from the vertical screen usage mode to the horizontal screen usage mode; and the first operation mode is the horizontal screen usage mode, and the second operation mode is the vertical screen usage mode. A specific implementation of the steps S10-S50 in the embodiment of the present application may be described as follows.

When the tablet computer is in the horizontal screen usage mode, the main interface image may be displayed in the first size on the first display area of the display screen, and it may be detected whether the first operation of switching the operation mode of the tablet computer from the horizontal screen usage mode to the vertical screen usage mode is obtained, wherein the first display area is any of areas on the display screen, and the first size is no more than the size of the display screen.

The particular detection approach is: detecting whether a change occurs on an included angle of the tablet computer relative to a first preset plane (e.g., ground). Since a gravity sensor may calculate an inclination angle of the electronic device relative to the horizontal plane by measuring variation of an acceleration caused by the gravity, it may be detected by the gravity sensor whether there is a change occurring on the included angle of the electronic device relative to the ground. In particular, a first angle value of the included angle of the tablet computer relative to the ground, e.g., 0°, may be firstly obtained, then a second angle value of the included angle of the tablet computer relative to the ground may be obtained. If the obtained second angle value of the included angle of the tablet computer relative to the ground is 10°, it indicates that the first operation of switching the operation mode of the tablet computer from the horizontal screen usage mode to the vertical screen usage mode is obtained; and if the obtained second angle value of the included angle of the tablet computer relative to the ground is 0°, it indicates that the first operation of switching the operation mode of the tablet computer from the horizontal screen usage mode to the vertical screen usage mode is not obtained.

When the first operation of switching the operation mode of the tablet computer from the horizontal screen usage mode to the vertical screen usage mode is obtained, the operation mode of the tablet computer may be switched from the horizontal screen usage mode to the vertical screen usage mode in response to the first operation, and the second image may be displayed on the display screen.

When the tablet computer is in the vertical screen usage mode, the display screen has the first display area in the vertical screen usage mode and the second display area in the vertical screen usage mode, in which the first display area in the vertical screen usage mode is a long side area of the display screen, and the second display area in the vertical screen usage mode is any of areas on the display screen.

The first sub display content in the vertical screen usage mode, i.e., the display content corresponding to the vertical screen usage mode (such as a function adapted to be used in the vertical screen mode, an e-book reading application icon, an instant communication application icon), may be displayed on the long side area of the display screen. Simultaneously, the first image, i.e., the second image in the horizontal screen usage mode, and the image constituted by the display content corresponding to the horizontal screen usage mode may be displayed in any of areas on the display screen.

It may be judged whether a click operation on the long side area of the display screen is obtained on the touch display screen before the counted time of the timer in the tablet computer reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the second image in the horizontal screen usage mode and the image constituted by the display content corresponding to the horizontal screen usage mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the e-book reading function adapted to the current vertical screen usage mode, the display content corresponding to the vertical screen usage mode may be displayed started from the long side area of the display screen, until the touch display screen is fully filled with the display content corresponding to the vertical screen usage mode, i.e., the display content corresponding to the vertical screen usage mode may be zoomed-in to the full screen from the long side area, so that the user may select, from the display content corresponding to the vertical screen usage mode, the function needed to be used.

Application Scene Four

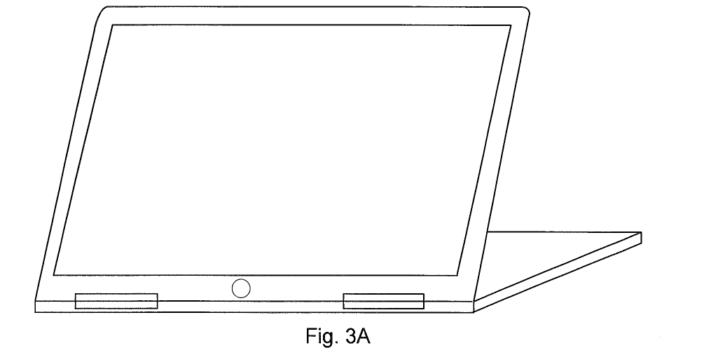

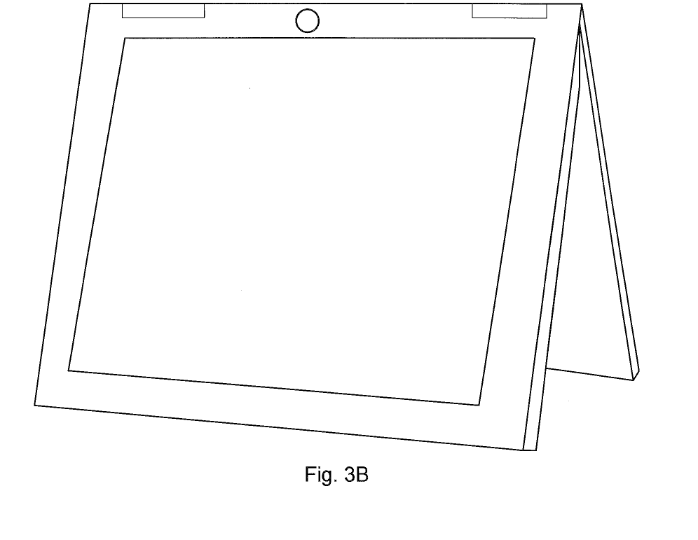

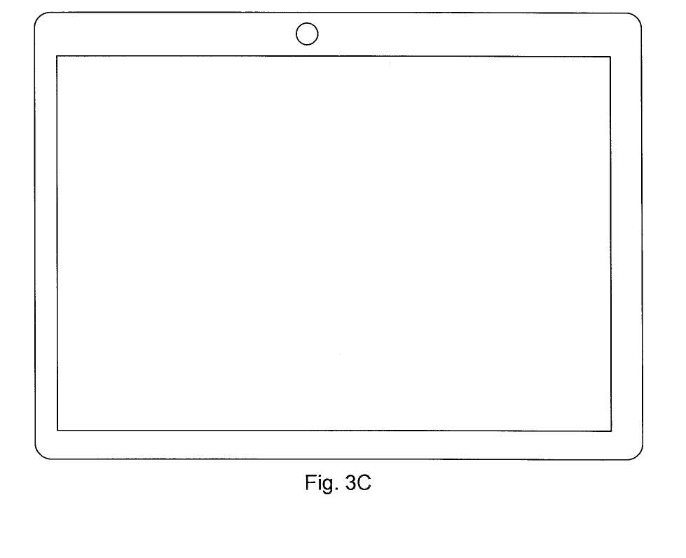

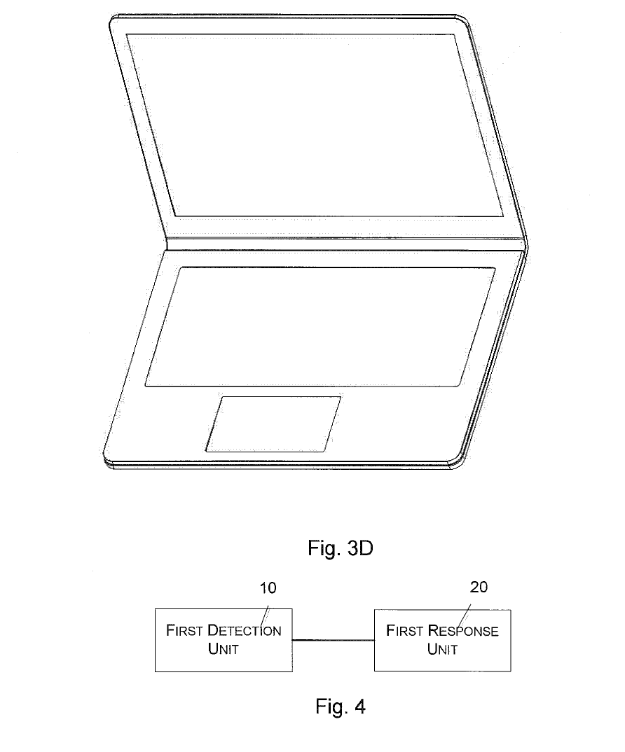

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is the main interface image corresponding to the notebook mode, the first operation mode is the notebook mode as shown in FIG. 3D, the second operation mode is the stand mode as shown in FIG. 3A, the tent mode as shown in FIG. 3B or the tablet mode as shown in FIG. 3B. A specific implementation of the steps S10-S50 in the embodiment of the present application may be described as follows.

When the multi-modality electronic device is in the notebook mode, the main interface image corresponding to the notebook mode may be displayed in the first size on the first display area of the display screen, and it may be detected whether the first operation of switching the operation mode of the multi-modality electronic device from the notebook mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is 270°, it indicates that the first operation of switching the multi-modality electronic device from the notebook mode to the stand mode is obtained; and if the obtained fourth angle value of the display screen relative to the first face of the second body is 360°, it indicates that the first operation of switching the multi-modality electronic device from the notebook mode to the tablet mode is obtained; if the obtained fourth angle value of the display screen relative to the first face of the second body is other angle values except 90°, 180°, 270° and 360°, it indicates that the first operation of switching the multi-modality electronic device from the notebook mode to the tent mode is obtained.

1) When the first operation of switching the multi-modality electronic device from the notebook mode to the stand mode is obtained, the operation mode of the multi-modality electronic device may be switched from the notebook mode to the stand mode in response to the first operation, and the second image may be displayed on the display screen.

When the multi-modality electronic device is in the stand mode, the display screen has the first display area in the stand mode and the second display area in the stand mode, in which the first display area in the stand mode is a long side area of the display screen, and the second display area in the stand mode is any of areas on the display screen.

The first sub display content in the stand mode, i.e., the display content corresponding to the stand mode (such as a function adapted to be used in the stand mode, an e-book reading application icon), may be displayed on the long side area of the display screen. Simultaneously, the first image, i.e., the main interface image corresponding to the notebook mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the main interface image corresponding to the notebook mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the e-book reading function adapted to the current stand mode, the display content corresponding to the stand mode may be displayed started from the long side area of the display screen, until the touch display screen is fully filled with the display content corresponding to the stand mode, i.e., the display content corresponding to the stand mode may be zoomed-in to the full screen from the long side area, so that the user may select, from the display content corresponding to the stand mode, the function needed to be used.

2) When the first operation of switching the multi-modality electronic device from the notebook mode to the tablet mode is obtained, the operation mode of the multi-modality electronic device may be switched from the notebook mode to the tablet mode in response to the first operation, and the second image may be displayed on the display screen.

When the multi-modality electronic device is in the tablet mode, the display screen has the first display area in the tablet mode and the second display area in the tablet mode, in which the first display area in the tablet mode is a long side area of the display screen, and the second display area in the tablet mode is any of areas on the display screen.

The first sub display content in the tablet mode, i.e., the display content corresponding to the tablet mode (such as a function adapted to be used in the tablet mode, a piano playing application icon), may be displayed on the long side area of the display screen. Simultaneously, the first image, i.e., the main interface image corresponding to the notebook mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the main interface image corresponding to the notebook mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the piano playing function adapted to the current tablet mode, the display content corresponding to the tablet mode may be displayed started from the long side area of the display screen, until the touch display screen is fully filled with the display content corresponding to the tablet mode, i.e., the display content corresponding to the tablet mode may be zoomed-in to the full screen from the long side area so that the user may select, from the display content corresponding to the tablet mode, the function needed to be used.

3) When the first operation of switching the multi-modality electronic device from the notebook mode to the tablet mode is obtained, the operation mode of the multi-modality electronic device may be switched from the notebook mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen.

The first sub display content in the tent mode, i.e., the display content corresponding to the tent mode (such as a function adapted to be used in the tent mode, a video playing application icon), may be displayed on the long side area of the display screen. Simultaneously, the first image, i.e., the main interface image corresponding to the notebook mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the main interface image corresponding to the notebook mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Application Scene Five

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is the main interface image corresponding to the stand mode, the first operation mode is the stand mode, the second operation mode is the tent mode or the tablet mode. A specific implementation of the steps S10-S50 in the embodiment of the present application may be described as follows.

When the multi-modality electronic device is in the stand mode, the main interface image corresponding to the stand mode may be displayed in the first size on the first display area of the display screen, and it may be detected whether the first operation of switching the operation mode of the multi-modality electronic device from the stand mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is 360°, it indicates that the first operation of switching the multi-modality electronic device from the stand mode to the tablet mode is obtained; and if the obtained fourth angle value of the display screen relative to the first face of the second body is other angle values except 90°, 180°, 270° and 360°, it indicates that the first operation of switching the multi-modality electronic device from the stand mode to the tent mode is obtained.

1) When the first operation of switching the multi-modality electronic device from the stand mode to the tablet mode is obtained, the operation mode of the multi-modality electronic device may be switched from the stand mode to the tablet mode in response to the first operation, and the second image may be displayed on the display screen.

When the multi-modality electronic device is in the tablet mode, the display screen has the first display area in the tablet mode and the second display area in the tablet mode, in which the first display area in the tablet mode is a long side area of the display screen, and the second display area in the tablet mode is any of areas on the display screen.

The first sub display content in the tablet mode, i.e., the display content corresponding to the tablet mode (such as a function adapted to be used in the tablet mode, a piano playing application icon), may be displayed on the long side area of the display screen. Simultaneously, the first image, i.e., the main interface image corresponding to the stand mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the main interface image corresponding to the stand mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the piano playing function adapted to the current tablet mode, the display content corresponding to the tablet mode may be displayed started from the long side area of the display screen, until the touch display screen is fully filled with the display content corresponding to the tablet mode, i.e., the display content corresponding to the tablet mode may be zoomed-in to the full screen from the long side area, so that the user may select, from the display content corresponding to the tablet mode, the function needed to be used.

2) When the first operation of switching the multi-modality electronic device from the stand mode to the tent mode is obtained, the operation mode of the multi-modality electronic device may be switched from the stand mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen. [0023T] The first sub display content in the tent mode, i.e., the display content corresponding to the tent mode (such as a function adapted to be used in the tent mode, a video playing application icon), may be displayed on the long side area of the display screen. Simultaneously, the first image, i.e., the main interface image corresponding to the stand mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the main interface image corresponding to the stand mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Application Scene Six

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is the main interface image corresponding to the tablet mode, the first operation mode is the tablet mode, the second operation mode is the tent mode. A specific implementation of the steps S10-S50 in the embodiment of the present application may be described as follows.

When the multi-modality electronic device is in the tablet mode, the main interface image corresponding to the tablet mode may be displayed in the first size on the first display area of the display screen, and it may be detected whether the first operation of switching the operation mode of the multi-modality electronic device from the tablet mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is other angle values except 90°, 180°, 270° and 360°, it indicates that the first operation of switching the multi-modality electronic device from the tablet mode to the tent mode is obtained.

When the first operation of switching the multi-modality electronic device from the tablet mode to the tent mode is obtained, the operation mode of the multi-modality electronic device may be switched from the tablet mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen.

The first sub display content in the tent mode, i.e., the display content corresponding to the tent mode (such as a function adapted to be used in the tent mode, a video playing application icon), may be displayed on the long side area of the display screen. Simultaneously, the first image, i.e., the main interface image corresponding to the tablet mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the main interface image corresponding to the tablet mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Application Scene Seven

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is a first application image of the first application running in the multi-modality electronic device when the multi-modality electronic device is in the notebook mode, e.g. the image run by the wordpad application running in the multi-modality electronic device, the first operation mode is the notebook mode, the second operation mode is the stand mode, the tent mode or the tablet mode. A specific implementation of the steps S10-S50 in the embodiment of the present application may be described as follows.

When the multi-modality electronic device is in the notebook mode, the image run by the wordpad application may be displayed in the first size on the first display area of the display screen, and it may be detected whether the first operation of switching the operation mode of the multi-modality electronic device from the notebook mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is 270°, it indicates that the first operation of switching the multi-modality electronic device from the notebook mode to the stand mode is obtained; and if the obtained fourth angle value of the display screen relative to the first face of the second body is 360°, it indicates that the first operation of switching the multi-modality electronic device from the notebook mode to the tablet mode is obtained; if the obtained fourth angle value of the display screen relative to the first face of the second body is other angle values except 90°, 180°, 270° and 360°, it indicates that the first operation of switching the multi-modality electronic device from the notebook mode to the tent mode is obtained.

1) When the first operation of switching the multi-modality electronic device from the notebook mode to the stand mode is obtained, the operation mode of the multi-modality electronic device may be switched from the notebook mode to the stand mode in response to the first operation, and the second image may be displayed on the display screen.

When the multi-modality electronic device is in the stand mode, the display screen has the first display area in the stand mode and the second display area in the stand mode, in which the first display area in the stand mode is a long side area of the display screen, and the second display area in the stand mode is any of areas on the display screen.

The first sub display content in the stand mode, i.e., the display content corresponding to the stand mode (such as a function adapted to be used in the stand mode, an e-book reading application icon), may be displayed on the long side area of the display screen. Simultaneously, the first image, i.e., the image run by the wordpad application in the multi-modality electronic device, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the image run by the wordpad application in the multi-modality electronic device to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the e-book reading function adapted to the current stand mode, the display content corresponding to the stand mode may be displayed started from the long side area of the display screen, until the touch display screen is fully filled with the display content corresponding to the stand mode, i.e., the display content corresponding to the stand mode may be zoomed-in to the full screen from the long side area, so that the user may select, from the display content corresponding to the stand mode, the function needed to be used.

2) When the first operation of switching the multi-modality electronic device from the notebook mode to the tablet mode is obtained, the operation mode of the multi-modality electronic device may be switched from the notebook mode to the tablet mode in response to the first operation, and the second image may be displayed on the display screen.

When the multi-modality electronic device is in the tablet mode, the display screen has the first display area in the tablet mode and the second display area in the tablet mode, in which the first display area in the tablet mode is a long side area of the display screen, and the second display area in the tablet mode is any of areas on the display screen.

The first sub display content in the tablet mode, i.e., the display content corresponding to the tablet mode (such as a function adapted to be used in the tablet mode, a piano playing application icon), may be displayed on the long side area of the display screen. Simultaneously, the first image, i.e., the image run by the wordpad application in the multi-modality electronic device, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the image run by the wordpad application in the multi-modality electronic device to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the piano playing function adapted to the current tablet mode, the display content corresponding to the tablet mode may be displayed started from the long side area of the display screen, until the touch display screen is fully filled with the display content corresponding to the tablet mode, i.e., the display content corresponding to the tablet mode may be zoomed-in to the full screen from the long side area, so that the user may select, from the display content corresponding to the tablet mode, the function needed to be used.

3) When the first operation of switching the multi-modality electronic device from the notebook mode to the tablet mode is obtained, the operation mode of the multi-modality electronic device may be switched from the notebook mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen.

The first sub display content in the tent mode, i.e., the display content corresponding to the tent mode (such as a function adapted to be used in the tent mode, a video playing application icon), may be displayed on the long side area of the display screen. Simultaneously, the first image, i.e., the image run by the wordpad application in the multi-modality electronic device, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the image run by the wordpad application in the multi-modality electronic device to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Application Scene Eight

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is a first application image of the first application running in the multi-modality electronic device when the multi-modality electronic device is in the stand mode, e.g. the image run by the wordpad application running in the multi-modality electronic device, the first operation mode is the stand mode, the second operation mode is the tent mode or the tablet mode. A specific implementation of the steps S10-S50 in the embodiment of the present application may be described as follows.

When the multi-modality electronic device is in the stand mode, the main interface image corresponding to the stand mode may be displayed in the first size on the first display area of the display screen, and it may be detected whether the first operation of switching the operation mode of the multi-modality electronic device from the stand mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is 360°, it indicates that the first operation of switching the multi-modality electronic device from the stand mode to the tablet mode is obtained; and if the obtained fourth angle value of the display screen relative to the first face of the second body is other angle values except 90°, 180°, 270° and 360°, it indicates that the first operation of switching the multi-modality electronic device from the stand mode to the tent mode is obtained.

1) When the first operation of switching the multi-modality electronic device from the stand mode to the tablet mode is obtained, the operation mode of the multi-modality electronic device may be switched from the stand mode to the tablet mode in response to the first operation, and the second image may be displayed on the display screen.

When the multi-modality electronic device is in the tablet mode, the display screen has the first display area in the tablet mode and the second display area in the tablet mode, in which the first display area in the tablet mode is a long side area of the display screen, and the second display area in the tablet mode is any of areas on the display screen.

The first sub display content in the tablet mode, i.e., the display content corresponding to the tablet mode (such as a function adapted to be used in the tablet mode, a piano playing application icon), may be displayed on the long side area of the display screen. Simultaneously, the first image, i.e., the image run by the wordpad application in the multi-modality electronic device, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the image run by the wordpad application in the multi-modality electronic device to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the piano playing function adapted to the current tablet mode, the display content corresponding to the tablet mode may be displayed started from the long side area of the display screen, until the touch display screen is fully filled with the display content corresponding to the tablet mode, i.e., the display content corresponding to the tablet mode may be zoomed-in to the full screen from the long side area, so that the user may select, from the display content corresponding to the tablet mode, the function needed to be used.

2) When the first operation of switching the multi-modality electronic device from the stand mode to the tent mode is obtained, the operation mode of the multi-modality electronic device may be switched from the stand mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen.

The first sub display content in the tent mode, i.e., the display content corresponding to the tent mode (such as a function adapted to be used in the tent mode, a video playing application icon), may be displayed on the long side area of the display screen. Simultaneously, the first image, i.e., the image run by the wordpad application in the multi-modality electronic device, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the image run by the wordpad application in the multi-modality electronic device to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Application Scene Nine

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is a first application image of the first application running in the multi-modality electronic device when the multi-modality electronic device is in the tablet mode, e.g. the image run by the wordpad application running in the multi-modality electronic device, the first operation mode is the tablet mode, the second operation mode is the tent mode. A specific implementation of the steps SI 0-S50 in the embodiment of the present application may be described as follows.

When the multi-modality electronic device is in the tablet mode, the main interface image corresponding to the tablet mode may be displayed in the first size on the first display area of the display screen, and it may be detected whether the first operation of switching the operation mode of the multi-modality electronic device from the tablet mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is other angle values except 90°, 180°, 270° and 360°, it indicates that the first operation of switching the multi-modality electronic device from the tablet mode to the tent mode is obtained.

When the first operation of switching the multi-modality electronic device from the tablet mode to the tent mode is obtained, the operation mode of the multi-modality electronic device may be switched from the tablet mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen.

The first sub display content in the tent mode, i.e., the display content corresponding to the tent mode (such as a function adapted to be used in the tent mode, a video playing application icon), may be displayed on the long side area of the display screen. Simultaneously, the first image, i.e., the image run by the wordpad application in the multi-modality electronic device, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the image run by the wordpad application in the multi-modality electronic device to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Application Scene Ten

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is a second image in the stand mode, the tent mode or the tablet mode, and an image constituted by the display content corresponding to the stand mode, the tent mode or the tablet mode, e.g. the image displayed on the display screen after the multi-modality electronic device is switched from the stand mode, the tent mode or the tablet mode to the notebook mode; the first operation mode is the notebook mode, the second operation mode is the stand mode, the tent mode or the tablet mode. A specific implementation of the steps S10-S50 in the embodiment of the present application may be described as follows.

When the multi-modality electronic device is in the notebook mode, the main interface image corresponding to the notebook mode may be displayed in the first size on the first display area of the display screen, and it may be detected whether the first operation of switching the operation mode of the multi-modality electronic device from the notebook mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is 270°, it indicates that the first operation of switching the multi-modality electronic device from the notebook mode to the stand mode is obtained; and if the obtained fourth angle value of the display screen relative to the first face of the second body is 360°, it indicates that the first operation of switching the multi-modality electronic device from the notebook mode to the tablet mode is obtained; if the obtained fourth angle value of the display screen relative to the first face of the second body is other angle values except 90°, 180°, 270° and 360°, it indicates that the first operation of switching the multi-modality electronic device from the notebook mode to the tent mode is obtained.

1) When the first operation of switching the multi-modality electronic device from the notebook mode to the stand mode is obtained, the operation mode of the multi-modality electronic device may be switched from the notebook mode to the stand mode in response to the first operation, and the second image may be displayed on the display screen.

When the multi-modality electronic device is in the stand mode, the display screen has the first display area in the stand mode and the second display area in the stand mode, in which the first display area in the stand mode is a long side area of the display screen, and the second display area in the stand mode is any of areas on the display screen.

The first sub display content in the stand mode, i.e., the display content corresponding to the stand mode (such as a function adapted to be used in the stand mode, an e-book reading application icon), may be displayed on the long side area of the display screen. Simultaneously, the first image, i.e., the second image in the stand mode, the tent mode or the tablet mode and the image constituted by the display content corresponding to the stand mode, the tent mode or the tablet mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the second image in the stand mode, the tent mode or the tablet mode and the image constituted by the display content corresponding to the stand mode, the tent mode or the tablet mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the e-book reading function adapted to the current stand mode, the display content corresponding to the stand mode may be displayed started from the long side area of the display screen, until the touch display screen is fully filled with the display content corresponding to the stand mode, i.e., the display content corresponding to the stand mode may be zoomed-in to the full screen from the long side area, so that the user may select, from the display content corresponding to the stand mode, the function needed to be used.

2) When the first operation of switching the multi-modality electronic device from the notebook mode to the tablet mode is obtained, the operation mode of the multi-modality electronic device may be switched from the notebook mode to the tablet mode in response to the first operation, and the second image may be displayed on the display screen.

When the multi-modality electronic device is in the tablet mode, the display screen has the first display area in the tablet mode and the second display area in the tablet mode, in which the first display area in the tablet mode is a long side area of the display screen, and the second display area in the tablet mode is any of areas on the display screen.

The first sub display content in the tablet mode, i.e., the display content corresponding to the tablet mode (such as a function adapted to be used in the tablet mode, a piano playing application icon), may be displayed on the long side area of the display screen. Simultaneously, the first image, i.e., the second image in the stand mode, the tent mode or the tablet mode and the image constituted by the display content corresponding to the stand mode, the tent mode or the tablet mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the second image in the stand mode, the tent mode or the tablet mode and the image constituted by the display content corresponding to the stand mode, the tent mode or the tablet mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the piano playing function adapted to the current tablet mode, the display content corresponding to the tablet mode may be displayed started from the long side area of the display screen, until the touch display screen is fully filled with the display content corresponding to the tablet mode, i.e., the display content corresponding to the tablet mode may be zoomed-in to the full screen from the long side area, so that the user may select, from the display content corresponding to the tablet mode, the function needed to be used.

3) When the first operation of switching the multi-modality electronic device from the notebook mode to the tablet mode is obtained, the operation mode of the multi-modality electronic device may be switched from the notebook mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen.

The first sub display content in the tent mode, i.e., the display content corresponding to the tent mode (such as a function adapted to be used in the tent mode, a video playing application icon), may be displayed on the long side area of the display screen. Simultaneously, the first image, i.e., the second image in the stand mode, the tent mode or the tablet mode and the image constituted by the display content corresponding to the stand mode, the tent mode or the tablet mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the second image in the stand mode, the tent mode or the tablet mode and the image constituted by the display content corresponding to the stand mode, the tent mode or the tablet mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Application Scene Eleven

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is a second image in the notebook mode, the tent mode or the tablet mode, and an image constituted by the display content corresponding to the notebook mode, the tent mode or the tablet mode, e.g. the image displayed on the display screen after the multi-modality electronic device is switched from the notebook mode, the tent mode or the tablet mode to the stand mode; the first operation mode is the stand mode, the second operation mode is the tent mode or the tablet mode. A specific implementation of the steps S10-S50 in the embodiment of the present application may be described as follows.

When the multi-modality electronic device is in the stand mode, the main interface image corresponding to the stand mode may be displayed in the first size on the first display area of the display screen, and it may be detected whether the first operation of switching the operation mode of the multi-modality electronic device from the stand mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is 360°, it indicates that the first operation of switching the multi-modality electronic device from the stand mode to the tablet mode is obtained; and if the obtained fourth angle value of the display screen relative to the first face of the second body is other angle values except 90°, 180°, 270° and 360°, it indicates that the first operation of switching the multi-modality electronic device from the stand mode to the tent mode is obtained.

1) When the first operation of switching the multi-modality electronic device from the stand mode to the tablet mode is obtained, the operation mode of the multi-modality electronic device may be switched from the stand mode to the tablet mode in response to the first operation, and the second image may be displayed on the display screen.

When the multi-modality electronic device is in the tablet mode, the display screen has the first display area in the tablet mode and the second display area in the tablet mode, in which the first display area in the tablet mode is a long side area of the display screen, and the second display area in the tablet mode is any of areas on the display screen.

The first sub display content in the tablet mode, i.e., the display content corresponding to the tablet mode (such as a function adapted to be used in the tablet mode, a piano playing application icon), may be displayed on the long side area of the display screen. Simultaneously, the first image, i.e., the second image in the notebook mode, the tent mode or the tablet mode, and the image constituted by the display content corresponding to the notebook mode, the tent mode or the tablet mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the second image in the notebook mode, the tent mode or the tablet mode, and the image constituted by the display content corresponding to the notebook mode, the tent mode or the tablet mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the piano playing function adapted to the current tablet mode, the display content corresponding to the tablet mode may be displayed started from the long side area of the display screen, until the touch display screen is fully filled with the display content corresponding to the tablet mode, i.e., the display content corresponding to the tablet mode may be zoomed-in to the full screen from the long side area, so that the user may select, from the display content corresponding to the tablet mode, the function needed to be used.

2) When the first operation of switching the multi-modality electronic device from the stand mode to the tent mode is obtained, the operation mode of the multi-modality electronic device may be switched from the stand mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen.

The first sub display content in the tent mode, i.e., the display content corresponding to the tent mode (such as a function adapted to be used in the tent mode, a video playing application icon), may be displayed on the long side area of the display screen. Simultaneously, the first image, i.e., the second image in the notebook mode, the tent mode or the tablet mode, and the image constituted by the display content corresponding to the notebook mode, the tent mode or the tablet mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the second image in the notebook mode, the tent mode or the tablet mode, and the image constituted by the display content corresponding to the notebook mode, the tent mode or the tablet mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Application Scene Twelve

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. And assuming that the first image is a second image in the stand mode, the tent mode or the notebook mode, and an image constituted by the display content corresponding to the stand mode, the tent mode or the notebook mode, e.g. the image displayed on the display screen after the multi-modality electronic device is switched from the stand mode, the tent mode or the notebook mode to the tablet mode; the first operation mode is the tablet mode, the second operation mode is the tent mode. A specific implementation of the steps S10-S50 in the embodiment of the present application may be described as follows.

When the multi-modality electronic device is in the tablet mode, the main interface image corresponding to the tablet mode may be displayed in the first size on the first display area of the display screen, and it may be detected whether the first operation of switching the operation mode of the multi-modality electronic device from the tablet mode to the second operation mode is obtained, wherein the first display area is any of areas on the display screen, and the first size is no more than the size of the display screen.

The particular detection approach is: detecting whether a change occurs on an included angle between the display screen and the first face of the second body. In particular, a third angle value of the display screen relative to the first face of the second body, e.g., 90°, may be firstly obtained, then a fourth angle value of the display screen relative to the first face of the second body may be obtained. If the obtained fourth angle value of the display screen relative to the first face of the second body is other angle values except 90°, 180°, 270° and 360°, it indicates that the first operation of switching the multi-modality electronic device from the tablet mode to the tent mode is obtained.

When the first operation of switching the multi-modality electronic device from the tablet mode to the tent mode is obtained, the operation mode of the multi-modality electronic device may be switched from the tablet mode to the tent mode in response to the first operation, and the second image may be displayed on the display screen.

When the multi-modality electronic device is in the tent mode, the display screen has the first display area in the tent mode and the second display area in the tent mode, in which the first display area in the tent mode is a long side area of the display screen, and the second display area in the tent mode is any of areas on the display screen.

The first sub display content in the tent mode, i.e., the display content corresponding to the tent mode (such as a function adapted to be used in the tent mode, a video playing application icon), may be displayed on the long side area of the display screen. Simultaneously, the first image, i.e., the second image in the stand mode, the tent mode or the notebook mode and the image constituted by the display content corresponding to the stand mode, the tent mode or the notebook mode, may be displayed in any of areas on the display screen.

It may be judged whether a click operation on the long side area of the display screen is obtained on the touch display screen before the counted time of the timer in the multi-modality electronic device reaches a preset value, i.e., it may be determined whether the user clicks the long side area of the display screen before the preset time has elapsed, in which the preset value may be 5 s, 3 s or 10 s etc., which is not limited here.

When the click operation on the long side area of the display screen is not obtained on the touch display screen, i.e., the user does not click the long side area of the display screen, which indicates that the user does not need the display content on the long side area of the display screen but only needs the second image in the stand mode, the tent mode or the notebook mode and the image constituted by the display content corresponding to the stand mode, the tent mode or the notebook mode to be displayed by the display screen, the long side area of the display screen may be closed.

When the click operation on the long side area of the display screen is obtained on the touch display screen, i.e., the user clicks the long side area of the display screen, which indicates that the user needs the display content on the long side area of the display screen, e.g. the user needs to use the video playing function adapted to the current tent mode, the display content corresponding to the tent mode may be displayed started from the long side area of the display screen, until the touch display screen is fully filled with the display content corresponding to the tent mode, i.e., the display content corresponding to the tent mode may be zoomed-in to the full screen from the long side area, so that the user may select, from the display content corresponding to the tent mode, the function needed to be used.

Further, the plurality of operation modes of the electronic device may be switched mutually. After steps S10-S20 are performed, the operation mode of the electronic device may be switched from the first operation mode to the second operation mode. Here, step S60, i.e. detecting whether a second operation of switching the operation mode of the electronic device from the second operation mode to the first operation mode is obtained, may also be performed.

After step S60, the information processing method according to the embodiment of the present application may proceed to step S70, i.e.

switching the operation mode of the electronic device from the second operation mode to the first operation mode in response to the second operation, when the second operation is obtained;

when the electronic device is in the first operation mode, the display screen has the first display area in the first operation mode and a second display area in the first operation mode, first sub display content in the first operation mode is displayed on the first display area in the first operation mode, and second sub display content in the first operation mode is displayed on the second display area in the first operation mode; and

wherein the first display area in the first operation mode is different from the second display area in the first operation mode, the first display sub-content in the first operation mode is different from the second display sub-content in the first operation mode, and the first display sub-content in the first operation mode is display content corresponding to the first operation mode.

Since the device patterns of the electronic device are different, the operation modes of the electronic device are different. Thus, the specific implementations of steps S60-S70 are also different. Hereinafter, the specific implementations of steps S60-S70 will be described in detail for different application scenes of the embodiment of the present application.

Application Scene One

Assuming that the pattern of the electronic device is the tablet computer, the first operation mode is the horizontal screen usage mode, and the second operation mode is the vertical screen usage mode, the operation mode of the tablet computer has been switched to the vertical screen usage mode from the horizontal screen usage mode. A specific implementation of the steps S60-S70 in the embodiment of the present application may be described as follows.

It may be detected whether the second operation of switching the operation mode of the electronic device from the vertical screen usage mode to the horizontal screen usage mode is obtained.

The particular detection approach is: detecting whether a change occurs on an included angle of the tablet computer relative to a first preset plane (e.g., ground). Since a gravity sensor may calculate an inclination angle of the electronic device relative to the horizontal plane by measuring variation of an acceleration caused by the gravity, it may be detected by the gravity sensor whether there is a change occurring on the included angle of the electronic device relative to the ground. In particular, a first angle value of the included angle of the tablet computer relative to the ground, e.g., 0°, may be firstly obtained, then a second angle value of the included angle of the tablet computer relative to the ground may be obtained. If the obtained second angle value of the included angle of the tablet computer relative to the ground is 10°, it indicates that the second operation of switching the operation mode of the tablet computer from the vertical screen usage mode to the horizontal screen usage mode is obtained; and if the obtained second angle value of the included angle of the tablet computer relative to the ground is 0°, it indicates that the first operation of switching the operation mode of the tablet computer from the vertical screen usage mode to the horizontal screen usage mode is not obtained.

When the second operation of switching the operation mode of the tablet computer from the vertical screen usage mode to the horizontal screen usage mode is obtained, the operation mode of the tablet computer may be switched from the vertical screen usage mode to the horizontal screen usage mode in response to the second operation.

When the tablet computer is in the horizontal screen usage mode, the display screen has the first display area in the horizontal screen usage mode and the second display area in the horizontal screen usage mode, in which the first display area in the horizontal screen usage mode is a short side area of the display screen, and the second display area in the horizontal screen usage mode is any of areas on the display screen.

The first sub display content in the horizontal screen usage mode, i.e., the display content corresponding to the horizontal screen usage mode (such as a function adapted to be used in the horizontal screen mode, the video playing application icon, the web page browsing application icon), may be displayed on the short side area of the display screen. Simultaneously, the second image, i.e., the image displayed on the display screen before the mode switching, may be displayed in any of areas on the display screen.

Application Scene Two

Assuming that the pattern of the electronic device is the multi-modality electronic device having a first body and a second body which are relatively rotatably connected via a shaft, the first face of the first body is provided with the display screen, and the first face of the second body is provided with an input apparatus such as a keyboard. The first operation mode is the notebook mode, the second operation mode is the stand mode, and the operation mode of the multi-modality electronic device has been switched to the stand mode from the notebook mode. Of course, the second operation mode may also be the tent mode or the tablet mode. Here, the stand mode is only taken as an example of the second operation mode for illustrating the process of switching operation modes mutually. A specific implementation of the steps S60-S70 in the embodiment of the present application may be described as follows.

It may be detected whether the second operation of switching the operation mode of the multi-modality electronic device from the stand mode to the notebook mode is obtained.

The particular detection approach is: detecting whether a change occurs on an included angle between the display screen and the first face of the second body. In particular, a third angle value of the display screen relative to the first face of the second body, e.g., 270°, may be firstly obtained, then a fourth angle value of the display screen relative to the first face of the second body may be obtained. If the obtained fourth angle value of the display screen relative to the first face of the second body is 90°, it indicates that the second operation of switching the multi-modality electronic device from the stand mode to the notebook mode is obtained; and if the obtained fourth angle value of the display screen relative to the first face of the second body is other angle values except 90°, it indicates that the second operation of switching the multi-modality electronic device from the stand mode to the notebook mode is not obtained.

When the second operation of switching the operation mode of the multi-modality electronic device from the stand mode to the notebook mode is obtained, the operation mode of the multi-modality electronic device may be switched from the stand mode to the notebook mode.

When the multi-modality electronic device is in the stand mode, the display screen has the first display area in the stand mode and the second display area in the stand mode, wherein the first display area in the stand mode is the long side area of the display screen, and the second display area in the stand mode is any of areas on the display screen.

The first sub display content in the stand mode, i.e., the display content corresponding to the stand mode (such as an icon corresponding to the function adapted to be used in the stand mode, particularly, a picture viewing application icon), may be displayed on the long side area of the display screen. Simultaneously, the second image, i.e., the image displayed on the display screen before mode switching, may be displayed in any of areas on the display screen.

Further, a second relative position relationship between the first display area in the second operation mode and the second display area in the second operation mode may be: not-overlapped with each other, or partly overlapped with each other; or

completely overlapped where the second display area in the second operation mode belongs to a part of the first display area in the second operation mode.

Further, the first display area in the second operation mode has a first size in the second operation mode, and the second display area in the second operation mode has a second size in the second operation mode, the first size in the second operation mode being different from the second size in the second operation mode.

Further, the second size in the second operation mode is less than the first size.

Further, a first relative position relationship between the first display area in the first operation mode and the second display area in the first operation mode is: not-overlapped with each other, or partly overlapped with each other, or

completely overlapped where the second display area in the first operation mode belongs to a part of the first display area in the first operation mode.

Further, the first display area in the first operation mode has a first size in the first operation mode, and the second display area in the first operation mode has a second size in the first operation mode, the first size in the first operation mode being different from the second size in the first operation mode.

Further, any two of the first display area in the first operation mode, the first display area in the second operation mode, and the second display area on the second operation mode are different; and

any two of the second display area in the first operation mode, the first display area in the second operation mode, and the second display area on the second operation mode are different

Hereinafter, assuming that the pattern of the electronic device is the tablet computer, the first image is the main interface image of the tablet computer, the first operation mode is the horizontal screen display mode, and the second operation mode is the vertical screen usage mode, such an example will be described for illustration. Of course, the pattern of the electronic device may also be the multi-modality electronic device or other patterns, the first image may also be the main interface image corresponding to the first operation mode or other images, and the operation mode may also be the stand mode or other modes, which will not be limited here but only for illustration.

The second relative position relationship between the first display area in the vertical screen usage mode and the second display area in the vertical screen usage mode is: not-overlapped with each other, or partly overlapped with each other; or completely overlapped where the second display area in the vertical screen usage mode belongs to a part of the first display area in the vertical screen usage mode. That is, the position relationship between the first display area in the vertical screen usage mode and the second display area in the vertical screen usage mode may be tiled, or partly overlapped, or the second display area in the vertical screen usage mode overlapped over the first display area in the vertical screen usage mode.

Similarly, the second relative position relationship between the first display area in the horizontal screen usage mode and the second display area in the horizontal screen usage mode is: not-overlapped with each other, or partly overlapped with each other; or completely overlapped where the second display area in the horizontal screen usage mode belongs to a part of the first display area in the horizontal screen usage mode. That is, the position relationship between the first display area in the horizontal screen usage mode and the second display area in the horizontal screen usage mode may be tiled, or partly overlapped, or the second display area in the horizontal screen usage mode overlapped over the first display area in the horizontal screen usage mode.

The first display area in the vertical screen usage mode has a first size in the vertical screen usage mode, and the second display area in the vertical screen usage mode has a second size in the vertical screen usage mode, the first size in the vertical screen usage mode being different from the second size in the vertical screen usage mode.

Similarly, the first display area in the horizontal screen usage mode has a first size in the horizontal screen usage mode, and the second display area in the horizontal screen usage mode has a second size in the horizontal screen usage mode, the first size in the horizontal screen usage mode being different from the second size in the horizontal screen usage mode.

The second size in the vertical screen usage mode is less than the first size in the vertical screen usage mode, i.e., in the vertical screen usage mode, the size of the second area is less than the size of the first area.

The first display area in the vertical screen usage mode is different from the first display area in the horizontal screen usage mode, and is different from the second display area in the horizontal screen usage mode; the second display area in the vertical screen usage mode is different from the first display area in the horizontal screen usage mode, and is different from the second display area in the horizontal screen usage mode.

Based on the same inventive concept, an embodiment of the present application further provides an electronic device. Since the principle of the device for solving the problem is similar with that of the information processing method, the implementation of the electronic device may refer to the implementation of the method. The description thereof will be omitted here.

As shown in FIG. 4, the electronic device may comprise: a first detection unit 10, configured for, when the electronic device is in the first operation mode, displaying a first image in a first size on a first display area of the display screen, and detecting whether a first operation of switching an operation mode of the electronic device from the first operation mode to the second operation mode is obtained;

a first response unit 20, configured for, when the first operation is obtained, switching the operation mode of the electronic device from the first operation mode to the second operation mode in response to the first operation, and displaying a second image on the display screen, the second image being different from the first image;

wherein when the electronic device is in the second operation mode, the display screen has a first display area in the second operation mode and a second display area in the second operation mode, first sub display content in the second operation mode is displayed on the first display area in the second operation mode, and second sub display content in the second operation mode is displayed on the second display area in the second operation mode; and

wherein the first display area in the second operation mode is different from the second display area in the second operation mode, the first display sub-content in the second operation mode is different from the second display sub-content in the second operation mode, and the first display sub-content in the second operation mode is display content corresponding to the second operation mode.

Further, the second sub display content in the second operation mode is the first image.

Further, a second relative position relationship between the first display area in the second operation mode and the second display area in the second operation mode is: not-overlapped with each other, or partly overlapped with each other; or

completely overlapped where the second display area in the second operation mode belongs to a part of the first display area in the second operation mode.

Further, the first display area in the second operation mode has a first size in the second operation mode, and the second display area in the second operation mode has a second size in the second operation mode, the first size in the second operation mode being different from the second size in the second operation mode.

Further, the second size in the second operation mode is less than the first size in the second operation mode.

Further, the first image is particularly:

an image of a main interface of the electronic device; or

an image of a first main interface corresponding to the first operation mode; or

an image consisting of the second sub display content in the first operation mode and the first sub display content in the first operation mode corresponding to the first operation mode; or

a first run image of a first application running in the electronic device, when the electronic device is in the first operation mode.

Further, the electronic device further comprises:

a first judging unit, configured for, judging whether a click operation on the first display area in the second operation mode is obtained on the touch display screen, before counted time of a timer in the electronic device reaches a predetermined value;

a first control unit, configure for closing the first display area in the second operation mode, when the click operation is not obtained on the touch display screen.

Further, the electronic device further comprises:

a second control unit, configured for closing the second display area in the second operation mode, when the click operation is obtained on the touch display screen;

wherein the first sub display content in the second operation mode is displayed in a direction from a first side of the touch display screen to a second side of the touch display screen opposite to the first side between a first instant and a second instant later than the first instant, and the touch display screen is fully filled with the first sub display content in the second operation mode at the second instant.

Further, the electronic device further comprises:

a second detection unit, configured for detecting whether a second operation of switching the operation mode of the electronic device from the second operation mode to the first operation mode is obtained;

a second response unit, configured for switching the operation mode of the electronic device from the second operation mode to the first operation mode in response to the second operation, when the second operation is obtained;

when the electronic device is in the first operation mode, the display screen has the first display area in the first operation mode and a second display area in the first operation mode, first sub display content in the first operation mode is displayed on the first display area in the first operation mode, and second sub display content in the first operation mode is displayed on the second display area in the first operation mode; and

wherein the first display area in the first operation mode is different from the second display area in the first operation mode, the first display sub-content in the first operation mode is different from the second display sub-content in the first operation mode, and the first display sub-content in the first operation mode is display content corresponding to the first operation mode.

Further, the second sub display content in the first operation mode is the second image.

Further, a first relative position relationship between the first display area in the first operation mode and the second display area in the first operation mode is: not-overlapped with each other, or partly overlapped with each other, or

completely overlapped where the second display area in the first operation mode belongs to a part of the first display area in the first operation mode.

Further, the first display area in the first operation mode has a first size in the first operation mode, and the second display area in the first operation mode has a second size in the first operation mode, the first size in the first operation mode being different from the second size in the first operation mode.

Further, wherein:

any two of the first display area in the first operation mode, the first display area in the second operation mode, and the second display area on the second operation mode are different; and

any two of the second display area in the first operation mode, the first display area in the second operation mode, and the second display area on the second operation mode are different.

Further, the electronic device has a first device pattern and a second device pattern, the first device pattern being different from the second device pattern.

Further, when the first device pattern is particularly a tablet computer pattern, the first operation mode is particularly a horizontal screen usage mode, and the second operation mode is particularly a vertical screen usage mode;

Switching the operation mode of the electronic device from the first operation mode to the second operation mode particularly comprises:

obtaining a first included angle of the electronic device relative to a preset plane at the first instant and when the electronic device is in the horizontal screen usage mode, wherein the first included angle is within a first included angle scope corresponding to the horizontal screen usage mode;

obtaining a second included angle of the electronic device relative to the preset plane at the second instant later than the first instant; and

switching the electronic device from the horizontal screen usage mode to the vertical screen usage mode, when the first included angle is different from the second included angle and the second included angle is within a second included angle scope corresponding to the vertical screen usage mode.

Further, when the display screen is in the vertical screen usage mode, at least one first type icon corresponding to at least one first type application matched with the vertical screen usage mode is displayed on the first display area in the vertical screen usage mode of the display screen.

Further, when the display screen is in the horizontal screen usage mode, at least one second type icon corresponding to at least one second type application matched with the horizontal screen usage mode is displayed on the first display area in the horizontal screen usage mode of the display screen.

Further, when the electronic device is in a multi-modality electronic device pattern, the electronic device has a first body and a second body which are relatively rotatably connected via a shaft, a second face of the first body is provided with the display screen, a third face of the second body is provided with an input apparatus, the first operation mode is particularly one of a stand mode, a notebook mode, a tent mode and a tablet mode;

the second operation mode is particularly one of the stand mode, the notebook mode, the tent mode and the tablet mode, the second operation mode being different from the first operation mode;

switching the operation mode of the electronic device from the first operation mode to the second operation mode particularly comprises:

obtaining a third included angle between the first body and the second body at the first instant and when the first operation mode is one of the stand mode, the notebook mode, the tent mode and the tablet mode owned by the electronic device, in which the third included angle is within a third included angle scope corresponding to the first operation mode;

obtaining a fourth included angle between the first body and the second body at the second instant later than the first instant; and

switching the electronic device from the first operation mode to another operation mode which is the second operation mode, when the fourth included angle is different from the third included angle and the fourth included angle is within a fourth included angle scope corresponding to another mode of the stand mode, the notebook mode, the tent mode and the tablet mode.

One or more technical solutions provided in the embodiments of the present application have at least technical effects or advantages as follows.

1. In the present application, during the operation mode of the electronic device is switched from the first operation mode to the second operation mode, the second sub display content in the second operation mode is displayed on the second display area in the second operation mode, while the first sub display content in the second operation mode is displayed on the first display area in the second operation mode of the display screen in the electronic device; and the first display sub-content in the second operation mode is the display content corresponding to the second operation mode.

For example, assuming that the electronic device is the tablet computer, during the operation mode of the tablet computer is switched from the horizontal screen usage mode to the vertical screen usage mode, at least one first type icon, e.g., an icon for reading the e-book corresponding to at least one first type application matched with the vertical screen usage mode may be displayed in a long side area on the display screen in the electronic device; and simultaneously, the first sub display content, e.g., the image previously displayed on the display screen before the operation mode is switched, in the vertical screen usage mode is displayed in any of areas in the display screen.

Therefore, the technical solution of the embodiments of the present application may effectively solve the technical problem of being not able to display, on the display screen of the electronic device, the display content corresponding to the switched operation mode during the operation mode of the electronic device is being switched, and achieve the technical effect of displaying, on the display screen of the electronic device, the display content corresponding to the switched operation mode during the operation mode of the electronic device is being switched. Thus, the users comfort degree of using the electronic device may be significantly improved.

2. When the electronic device is the tablet computer, the horizontal screen usage mode and the vertical screen usage mode of the tablet computer may be switched mutually, and during the switching, the display content corresponding to the current operation mode may be displayed. For example, after the tablet computer is switched from the horizontal screen usage mode to the vertical screen usage mode, the display content corresponding to the vertical screen usage mode, e.g., the icon corresponding to the e-book application, may be displayed; and after the tablet computer is switched from the vertical screen usage mode to the horizontal screen usage mode, the display content corresponding to the horizontal screen usage mode, e.g., an icon corresponding to web-page browsing, may be displayed. Since the display content corresponding to the current operation mode may be displayed after the operation mode is switched, the corresponding icon may be clicked conveniently and rapidly, and then the corresponding function may be used, the user experience degree may be improved.

3. When the electronic device is a multi-modality electronic device, the four modes of the multi-modality electronic device, i.e., the stand mode, the notebook mode, the tent mode and the tablet mode, may be switched mutually, and during the switching, the display content corresponding to the current operation mode may be displayed. For example, the display content corresponding to the tent mode, e.g., an icon corresponding to an video playing application, may be displayed after the electronic device is switched from the stand mode to the tent mode; the display content corresponding to the stand mode, e.g., an icon corresponding to a picture viewing application, may be displayed after the electronic device is switched from the tent mode to the stand mode. Since the display content corresponding to the current operation mode may be displayed after the operation mode is switched, the corresponding icon may be clicked conveniently and rapidly, and then the corresponding function may be used, the user experience degree may be improved.

4. Since the timer in the electronic device is used for time counting, it may be detected whether the user clicks the display content corresponding to the current operation mode, before the counted time reaches the predetermined value. If the display content corresponding to the current operation mode is clicked, the display content may be displayed from one side of the display screen to fully fill the whole display screen, if the display content corresponding to the current operation mode is not clicked, the display content may be closed. Therefore, the user may be provided with a convenient and rapid selection of opening the application corresponding to the current operation mode, and since the whole display screen is fully filled with the display content corresponding to the current operation mode, the user may select from a plurality of applications corresponding to the current operation mode, which improves the user experience.

### Other Embodiments

When the user handholds the electronic device, sometimes he may only hold the electronic device by a single hand. Some electronic device has a larger size, e.g. PAD, if the user wants to click the icon on the display screen thereof, it is possible that the icon cannot be clicked by the single hand due to a longer distance.

An embodiment of the present application provides a display method. The method may be applied in an electronic device having a display unit. The method may comprise: obtaining first operation information for the electronic device; displaying a side column by the display unit according to the first operation information, the side column including at least a first part and a second part; wherein the first part is used for prompting a current usage mode of the electronic device to a user, and the second part comprises at least one interactive object.

In the embodiment of the present application, after the first operation information is obtained by the electronic device, the side column may be displayed. The side column is obviously located at the side of the display unit. The user may operate on the interactive object in the side column even if he holds the electronic device by a single hand, and can click the interactive object since the distance is not so far. Thus, convenience of operations on the electronic device may be significantly improved.

In order to clarify objects, technical solutions, advantages of the embodiments of the present disclosure, the technical solutions in the embodiments of the present disclosure will be described clearly and completely in connection with drawings in the embodiments of the present disclosure. Obviously, the embodiments described are only parts of embodiments of the present disclosure, but not all of the embodiments. Based on the embodiments in the present disclosure, all other embodiments contemplated by the skilled in the art without creative labor also belong to protection scope of the present disclosure.

In the embodiment of the present disclosure, the electronic device may be a PC (Personal Computer), a notebook, a PAD (tablet computer), a mobile phone etc. The present disclosure does not make any limitation here.

In addition, the term “and/or” here is only an association relationship, representing three relationships. For example, A and/or B may represent three cases: there is only A; there are both A and B; and there is only B. Furthermore, the symbol “I” here generally represents that the associated objects before and after “I” is in an “or” relationship.

Hereinafter, preferred embodiments of the present disclosure will be described in detail in connection with the drawings.

### Example One

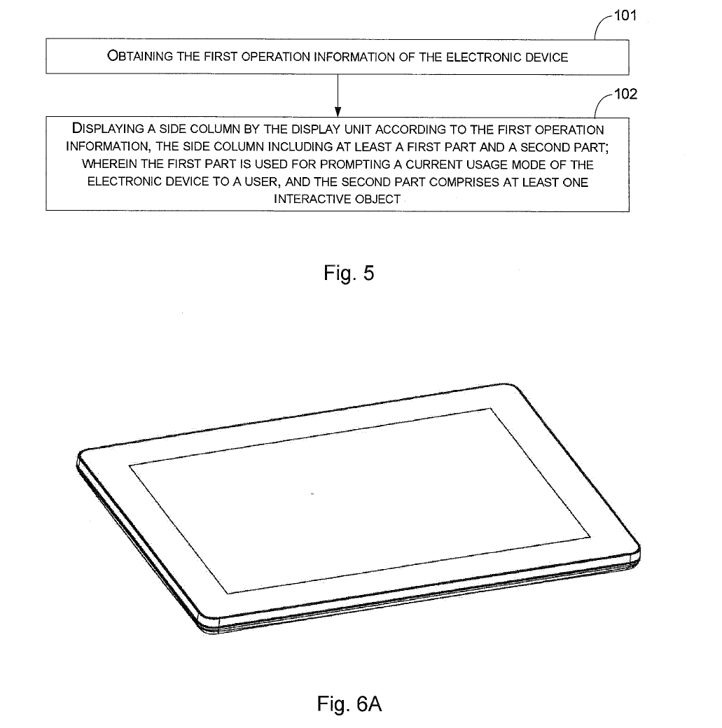

Referring to FIG. 5, an embodiment of the present disclosure provides a display method. The method may be applied in an electronic device. The main flowchart of the method will be described as follows.

Step 101 of obtaining the first operation information of the electronic device.

For example, the user may perform the first operation on the electronic device. After the electronic device obtains the first operation, the first operation information corresponding to the first operation may be determined.

Alternatively, the first operation may be an operation for changing the usage mode of the electronic device, and thus the first operation information may be operation information for changing the usage mode of the electronic device. For example, the user may change the usage mode of the electronic device by changing the pattern of the electronic device.

For example, if the electronic device is the PAD, the electronic device may have, but not limited to, two usage modes.

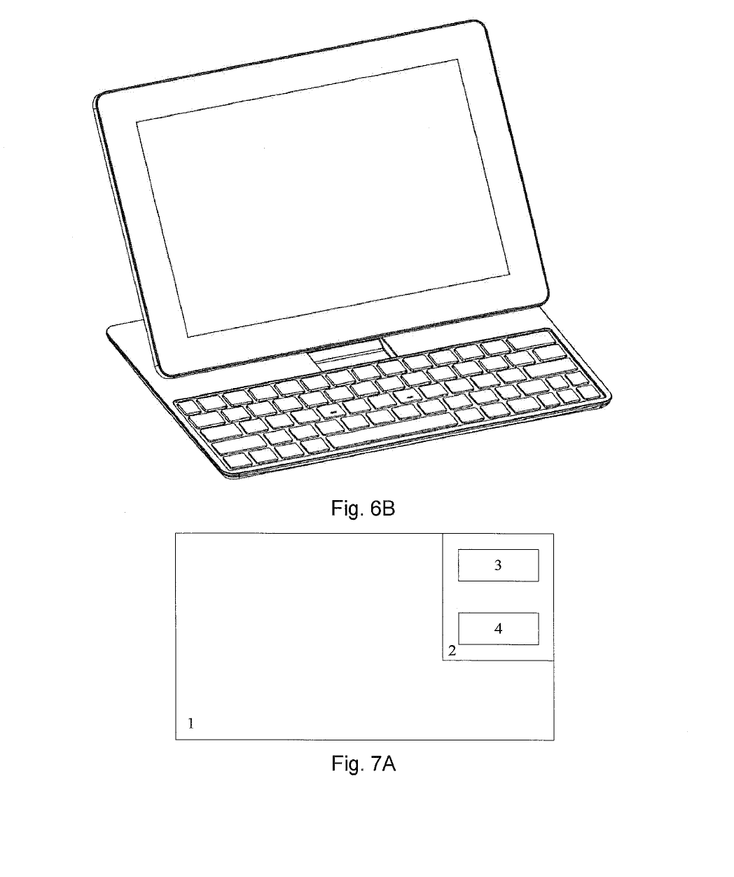

First, the tablet mode. As shown in FIG. 6A, when the electronic device is in a flat state, the usage mode of the electronic device may be the tablet mode. In this usage mode, the user may hold the electronic device by a single hand or by two hands for use.

Second, the stand mode. As shown in FIG. 6B, FIG. 6B also shows an input apparatus constituted by a keyboard. The electronic device may have the input apparatus by its own, or the electronic device may be externally connected with the input apparatus, or the electronic device may not have the input apparatus. For example, the electronic device may be in the stand mode by supporting of a support body. When the electronic device is in the tablet mode, the support body may be separated from the electronic device, or the support body may be embedded in a second face of the electronic device. For example, the display unit is located on the first face of the electronic device, thus the second face may be a face opposite to the first face. In the stand mode, the user may use the electronic device for watching videos, browsing web pages etc. or may input information. The usage mode is a mode easily operated by the user.

When the user wants to change the usage mode of the electronic device, the pattern of the electronic device may be changed. When the electronic device determines that its own pattern has been changed, the electronic device may control the usage mode to be changed. For example, the electronic device is the PAD, whose usage modes may be the tablet mode as shown in FIG. 6A and the stand mode as shown in FIG. 6B.

For example, at the first instant, the electronic device is in the stand mode, the electronic device may be e.g. in the stand mode by supporting of the support body. If the user wants to change the usage mode of the electronic device, the user may rotate the support body to the second face of the electronic device, i.e., folding the support body. Here, the electronic device is changed from the stand mode to the tablet mode. When the electronic device detects that its own pattern has been changed, the electronic device may control its own usage mode to be changed.

Alternatively, the first operation may be an operation of pressing a specific key in the electronic device, then the first operation information may be operation information indicating that the specific key in the electronic device is pressed. The specific key may be a physical key, or a virtual key, e.g., the specific key may be a virtual button displayed on the display unit.

Alternatively, the first operation may be an operation of sliding in the display unit. For example, the first operation is the operation of sliding in the display unit by an operation body, then the first operation information may be operation information indicating sliding in the display unit. For example, the operation body may be the user's finger, or a stylus, or other possible operation bodies.

Step 102 of displaying a side column by the display unit according to the first operation information, the side column including at least a first part and a second part; wherein the first part is used for prompting a current usage mode of the electronic device to a user, and the second part comprises at least one interactive object.

In the embodiment of the present disclosure, after the electronic device obtains the first operation information, the side column may be displayed by the display unit, the side column including at least the first part and the second part.

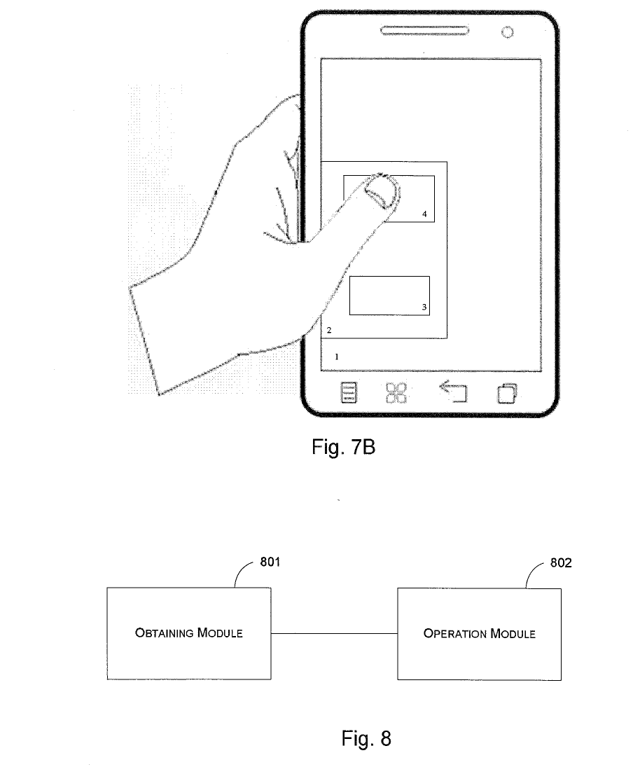

For example, as shown in FIG. 7A, the number 1 in FIG. 7A indicates the display unit, the number 2 indicates the side column, the number 3 indicates the first part, the number 4 indicates the second part, i.e., the interactive object. FIG. 7A only shows one interactive object for illustration.

It may be seen from FIG. 7A that the side column is located at one side of the display unit.

Preferably, the electronic device may detect the position where the operation body of the electronic device is held, i.e., generally the position where the hand of the user of the electronic device is placed. For example, if it is detected and determined that the user's hand is placed at the first place of the electronic device, the electronic device may control the side column to be displayed at the position on the display unit corresponding to the first position.

For example, as shown in FIG. 7B which is a schematic diagram of holding the electronic device by one hand of the user, the mobile phone may be taken as an example of the electronic device in FIG. 7B. The number 1 in FIG. 7B indicates the display unit, the number 2 indicates the side column, the number 3 indicates the first part, the number 4 indicates the second part, i.e., the interactive object. FIG. 7B only shows one interactive object for illustration. In FIG. 7B, parts of lines of the display unit and the second part are shielded by the user's hand. The number 5 in FIG. 7B indicates the first location. It may be seen that the side column is displayed at a position on the display unit corresponding to the first location; especially when the user holds the electronic device by the single hand, another hand might be unable to operate, since the side column is displayed at the position corresponding to the first location, the hand for holding the electronic device may also touch the first part and the second part in the side column. Thus, the user may perform the corresponding operation, and won't be unable to operate due to a long distance from the icon, which may improve the convenience of the user operations.

Preferably, in the embodiment of the present disclosure, if the first operation information is the operation information sliding in the display unit, displaying the side column by the display unit according to the first operation information may particularly comprise: determining a first operation track corresponding to the first operation information; and controlling an edge of the side column to be unfolded along a movement direction of the first operation track in the display unit.

For example, when the side column needs to be displayed, the user's finger may slide toward the middle of the display unit along the edge of the display unit, i.e., the user has performed the first operation, the electronic device may obtain the first operation; after the first operation is obtained, the electronic device may determine the first operation information corresponding to the first operation; since the first operation performed by the user is a sliding operation, the electronic device may determine, according to the first operation information, the first operation track corresponding to the first operation information, as well as the movement direction of the first operation track. Thus, the user may control the edge of the side column to be unfolded along the movement direction of the first operation track. It may be regarded as “pulling a curtain close”. With sliding of the user's finger, the side column may be unfolded on the display unit like the “curtain”. Such an open approach may bring a real and interesting experience to the user.

Further, in an embodiment of the present disclosure, after the side column is displayed by the display unit according to the first operation information, the method may further comprise: obtaining second operation information for a first interactive object; and displaying by the electronic device a first display window corresponding to the first interactive object via the display unit and forbidding displaying the side column, after the second operation information is obtained.

After the side column is displayed, the user may operate on the second part in the side column, i.e., may operate on the at least one interactive object.

In the embodiment of the present disclosure, when the electronic device is in different usage modes, the interactive objects may also be different.

For example, the PAD is still taken as the example of the electronic device. When the electronic device is in the tablet mode, the interactive object may be e.g. a game object, or other objects. If the interactive object is the game object, it may be e.g. the game object displayed randomly, or the game object recently viewed by the user, or the game object in which the user is interested etc. When the electronic device is in the tablet mode, the user may want to play game, and when the electronic device is in the tablet mode, it is more appropriate to play game. Thus, the interactive object may be the game object, which is not only convenient for user's operation, but can also satisfy the user's requirements as far as possible.

For example, when the electronic device is in the stand mode, the interactive object may be e.g. a multimedia object, or a document object, or other objects. If the interactive object is the multimedia object, it may be e.g. the multimedia object displayed randomly, or the multimedia object recently viewed by the user, or the multimedia object in which the user is interested etc. When the electronic device is in the stand mode, the user may want to view videos, images etc., and when the electronic device is in the stand mode, it is more appropriate to view videos, images etc. Thus, the interactive object may be the multimedia object, which is not only convenient for user's operation, but can also satisfy the user's requirements as far as possible.

For example, the second part may include two interactive objects, which are an interactive object 1 and an interactive object 2 respectively. For example, the user has performed the second operation on the interactive object 1, and the electronic device may determine the second operation information corresponding to the second operation after the second operation is obtained. Then, the electronic device may invoke the first display window corresponding to the first interactive object 1, the display unit may display the first display window; and when the display unit displays the first display window, or when the electronic device obtains the first operation, the electronic device may control the display unit to forbid displaying the side column. That is, when a new display window is opened in the display unit, the electronic device may forbid the side column to be displayed, and does not affect the user viewing the display content in the first display window as far as possible.

Preferably, in the embodiment of the present disclosure, if the user performs an operation of closing the first display window, e.g. the user performs a fourth operation, the electronic device may determine fourth operation information corresponding to the fourth operation after the fourth operation is obtained. Then, the electronic device may close the first display window according to the fourth operation information.

When the first display window is closed, the electronic device may continue to forbid displaying the side column. The electronic device may display the side column again until the first operation is obtained again. Or, when the first display window is closed, the electronic device may re-display the side column without the first operation being performed again by the user. This may save operation steps and improve response efficiency, so that the user may operate other interactive objects again conveniently.

Further, in an embodiment of the present disclosure, after the side column is displayed by the display unit according to the first operation information, the method may further comprise: obtaining third operation information for the electronic device, and forbidding displaying the side column according to the third operation information.

For example, when the side column is displayed by the display unit, the user may want to close the side column. Then, the user may perform a third operation. The electronic device may determine third operation information corresponding to the third operation after the third operation is obtained. When the third operation information is determined, the electronic device may forbid the side column to be displayed according to the third operation information.

Alternatively, in the embodiment of the present disclosure, the third operation may be an operation for changing the usage mode of the electronic device, and then the third operation information may be operation information for changing the usage mode of the electronic device. For example, the user may change the usage mode of the electronic device by changing the pattern of the electronic device.

Alternatively, in the embodiment of the present disclosure, the third operation may be an operation of pressing a specific key in the electronic device, and then the third operation information may be operation information indicating that the specific key in the electronic device is pressed. The specific key may be a physical key, or a virtual key, e.g., the specific key may be a virtual button displayed on the display unit.

Alternatively, the third operation may be an operation of sliding in the display unit. For example, the third operation is the operation of sliding in the display unit by an operation body, then the third operation information may be operation information indicating sliding in the display unit. For example, the operation body may be the user's finger, or a stylus, or other possible operation bodies.

Preferably, in the embodiment of the present disclosure, if the third operation is the operation information indicating sliding in the display unit, forbidding displaying the side column according to the third operation information may particularly be: determining a third operation track corresponding to the third operation information, and controlling an edge of the side column to be folded along a movement direction of the third operation track in the display unit.

For example, when the side column needs be forbidden to be displayed, the user's finger may slide toward the edge of the display unit along the middle of the display unit, i.e., the user has performed the third operation, the electronic device may obtain the third operation; after the third operation is obtained, the electronic device may determine the third operation information corresponding to the third operation; since the third operation performed by the user is a sliding operation, the electronic device may determine, according to the third operation information, the third operation track corresponding to the third operation information, as well as the movement direction of the third operation track. Thus, the user may control the edge of the side column to be folded along the movement direction of the third operation track. It may be regarded as “pulling a curtain open”. With sliding of the user's finger, the side column may be folded on the display unit like the “curtain”. Such an open approach may bring a real and interesting experience to the user.

### Example Two

Referring to FIG. 8, an embodiment of the present disclosure provides an electronic device. The electronic device may have a display unit, and may further comprise an obtaining module 801 and an operation module 802.

The obtaining module 801 may be configured for obtaining first operation information for the electronic device.

The operation module 802 may be configured for displaying a side column by the display unit according to the first operation information, the side column including at least a first part and a second part; wherein the first part is used for prompting a current usage mode of the electronic device to a user, and the second part comprises at least one interactive object.

Preferably, the obtaining module 801 may particularly be configured for obtaining the first operation information for changing the usage mode of the electronic device; or obtaining the first operation information indicating that a specific key of the electronic device is pressed; or obtaining the first operation information indicating sliding in the display unit.

Preferably, when the first operation information indicating sliding in the display unit is obtained, the operation module 802 may particularly be configured for determining a first operation track corresponding to the first operation information; and controlling an edge of the side column to be unfolded along a movement direction of the first operation track in the display unit.

Preferably, the obtaining module 801 may further be configured for obtaining second operation information for a first interactive object.

Preferably, the operation module 802 may further be configured for displaying a first display window corresponding to the first interactive object by the display unit, and forbidding displaying the side column.

Preferably, the obtaining module 801 may further be configured for obtaining third operation information for the electronic device.

Preferably, the operation module 802 may further be configured for forbidding displaying the side column according to the third operation information.

Preferably, when the third operation information is the operation information indicating sliding in the display unit, the operation module 802 may particularly be configured for determining a third operation track corresponding to the third operation information, and controlling an edge of the side column to be folded along a movement direction of the third operation track in the display unit.

Preferably, when the current usage modes of the electronic device are different, the interactive objects may also be different.

The embodiment of the present application provides a display method. The method may be applied in an electronic device having a display unit. The method may comprise: obtaining first operation information for the electronic device; displaying a side column by the display unit according to the first operation information, the side column including at least a first part and a second part; wherein the first part is used for prompting a current usage mode of the electronic device to a user, and the second part comprises at least one interactive object.

In the embodiment of the present application, after the first operation information is obtained by the electronic device, the side column may be displayed. The side column is obviously located at the side of the display unit. The user may operate on the interactive object in the side column even if he holds the electronic device by a single hand, and can click the interactive object since the distance is not so far. Thus, convenience of operations on the electronic device may be significantly improved.

It may be well understood by the skilled in the art that division of various functional modules as described above is illustrated only as an example for convenience and conciseness of the description. In practical applications, the above functional allocation may be implemented by different functional modules as needed, i.e., the internal structure of the apparatus may be divided into different functional modules so as to implement all or part of functions as described above. Particular working procedures of the system, the apparatus and the unit as described above may refer to the corresponding process in the method embodiment. The description thereof will be omitted here.

It can be appreciated from the embodiments of the present application that the disclosed device and method can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

Further, all the functional units in various embodiments of the present disclosure can be integrated within one processing unit, or each of these units can be a separate unit, or two or more units can be integrated into one unit. Such integrated unit can be implemented in hardware, possibly in combination with software functional units.

When the integrated units are implemented in software functional modules and sold or used as an independent product, they can be stored in a computer readable storage medium. In view of this, the technical solutions according to the embodiments of the present application, or in other words a part thereof which makes contribution over, can be substantially embodied in a form of software product. The computer software product can be stored in a storage media, such as a U disc, a portable hard disc, a read-only memory (ROM), a random access memory (RAM), a magnetic disc or an optical disc and the like, containing instructions which cause a computer device (which can be a personal computer, a server, a network device or the like) to perform all or part of steps of the methods according to various embodiments of the present application.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims as attached.

Obviously, various modifications and variants can be made to the present invention by those skilled in the art without departing from the spirit and scope of the present invention. Therefore, these modifications and variants are to be encompassed by the present invention if they fall within the scope of the present invention as defined by the claims and their equivalents.

1. An information processing method applied in an electronic device, the electronic device having a display screen and at least a first operation mode and a second operation mode different from the first operation mode, the method comprising:
when the electronic device is in the first operation mode, displaying a first image in a first size on a first display area of the display screen, and detecting whether a first operation of switching an operation mode of the electronic device from the first operation mode to the second operation mode is obtained;
when the first operation is obtained, switching the operation mode of the electronic device from the first operation mode to the second operation mode in response to the first operation, and displaying a second image on the display screen, the second image being different from the first image;
wherein when the electronic device is in the second operation mode, the display screen has a first display area in the second operation mode and a second display area in the second operation mode, first sub display content in the second operation mode is displayed on the first display area in the second operation mode, and second sub display content in the second operation mode is displayed on the second display area in the second operation mode; and
wherein the first display area in the second operation mode is different from the second display area in the second operation mode, the first display sub-content in the second operation mode is different from the second display sub-content in the second operation mode, and the first display sub-content in the second operation mode is display content corresponding to the second operation mode.

2. The method according to claim 1, wherein the second sub display content in the second operation mode is the first image.

3. The method according to claim 1, wherein a second relative position relationship between the first display area in the second operation mode and the second display area in the second operation mode is: not-overlapped with each other, or partly overlapped with each other; or
completely overlapped where the second display area in the second operation mode belongs to a part of the first display area in the second operation mode.

4. The method according to claim 1, wherein the first display area in the second operation mode has a first size in the second operation mode, and the second display area in the second operation mode has a second size in the second operation mode, the first size in the second operation mode being different from the second size in the second operation mode.

5. The method according to claim 1, wherein the first image is particularly:
an image of a main interface of the electronic device; or
an image of a first main interface corresponding to the first operation mode; or
an image consisting of the second sub display content in the first operation mode and the first sub display content in the first operation mode corresponding to the first operation mode; or
a first run image of a first application running in the electronic device, when the electronic device is in the first operation mode.

6. The method according to claim 1, wherein when the display screen is a touch display screen, after the second sub display content in the second operation mode displayed on the second display area in the second operation mode of the display screen, the method further comprises:
judging whether a click operation on the first display area in the second operation mode is obtained on the touch display screen, before counted time of a timer in the electronic device reaches a predetermined value;
closing the first display area in the second operation mode, when the click operation is not obtained on the touch display screen.

7. The method according to claim 1, wherein after the operation mode of the electronic device is switched from the first operation mode to the second operation mode in response to the first operation when the first operation is obtained, the method further comprises:
detecting whether a second operation of switching the operation mode of the electronic device from the second operation mode to the first operation mode is obtained;
switching the operation mode of the electronic device from the second operation mode to the first operation mode in response to the second operation, when the second operation is obtained;
when the electronic device is in the first operation mode, the display screen has the first display area in the first operation mode and a second display area in the first operation mode, first sub display content in the first operation mode is displayed on the first display area in the first operation mode, and second sub display content in the first operation mode is displayed on the second display area in the first operation mode; and
wherein the first display area in the first operation mode is different from the second display area in the first operation mode, the first display sub-content in the first operation mode is different from the second display sub-content in the first operation mode, and the first display sub-content in the first operation mode is display content corresponding to the first operation mode.

8. An electronic device, comprising:
a first detection unit, configured for, when the electronic device is in the first operation mode, displaying a first image in a first size on a first display area of the display screen, and detecting whether a first operation of switching an operation mode of the electronic device from the first operation mode to the second operation mode is obtained;
a first response unit, configured for, when the first operation is obtained, switching the operation mode of the electronic device from the first operation mode to the second operation mode in response to the first operation, and displaying a second image on the display screen, the second image being different from the first image;
wherein when the electronic device is in the second operation mode, the display screen has a first display area in the second operation mode and a second display area in the second operation mode, first sub display content in the second operation mode is displayed on the first display area in the second operation mode, and second sub display content in the second operation mode is displayed on the second display area in the second operation mode; and
wherein the first display area in the second operation mode is different from the second display area in the second operation mode, the first display sub-content in the second operation mode is different from the second display sub-content in the second operation mode, and the first display sub-content in the second operation mode is display content corresponding to the second operation mode.

9. The electronic device according to claim 8, wherein the second sub display content in the second operation mode is the first image.

10. The electronic device according to claim 8, wherein a second relative position relationship between the first display area in the second operation mode and the second display area in the second operation mode is: not-overlapped with each other, or partly overlapped with each other; or
completely overlapped where the second display area in the second operation mode belongs to a part of the first display area in the second operation mode.

11. The electronic device according to claim 8, wherein the first display area in the second operation mode has a first size in the second operation mode, and the second display area in the second operation mode has a second size in the second operation mode, the first size in the second operation mode being different from the second size in the second operation mode.

12. The electronic device according to claim 8, wherein the first image is particularly:
an image of a main interface of the electronic device; or
an image of a first main interface corresponding to the first operation mode; or
an image consisting of the second sub display content in the first operation mode and the first sub display content in the first operation mode corresponding to the first operation mode; or
a first run image of a first application running in the electronic device, when the electronic device is in the first operation mode.

13. The electronic device according to claim 8, further comprising:
a first judging unit, configured for, judging whether a click operation on the first display area in the second operation mode is obtained on the touch display screen, before counted time of a timer in the electronic device reaches a predetermined value;
a first control unit, configure for closing the first display area in the second operation mode, when the click operation is not obtained on the touch display screen.

14. The electronic device according to claim 13, further comprising:
a second control unit, configured for closing the second display area in the second operation mode, when the click operation is obtained on the touch display screen;
wherein the first sub display content in the second operation mode is displayed in a direction from a first side of the touch display screen to a second side of the touch display screen opposite to the first side between a first instant and a second instant later than the first instant, and the touch display screen is fully filled with the first sub display content in the second operation mode at the second instant.

15. The electronic device according to claim 8, further comprising:
a second detection unit, configured for detecting whether a second operation of switching the operation mode of the electronic device from the second operation mode to the first operation mode is obtained;
a second response unit, configured for switching the operation mode of the electronic device from the second operation mode to the first operation mode in response to the second operation, when the second operation is obtained;
when the electronic device is in the first operation mode, the display screen has the first display area in the first operation mode and a second display area in the first operation mode, first sub display content in the first operation mode is displayed on the first display area in the first operation mode, and second sub display content in the first operation mode is displayed on the second display area in the first operation mode; and
wherein the first display area in the first operation mode is different from the second display area in the first operation mode, the first display sub-content in the first operation mode is different from the second display sub-content in the first operation mode, and the first display sub-content in the first operation mode is display content corresponding to the first operation mode.

16. The electronic device according to claim 8, wherein the electronic device has a first device pattern and a second device pattern, the first device pattern being different from the second device pattern.

17. The electronic device according to claim 16, wherein
when the first device pattern is particularly a tablet computer pattern, the first operation mode is particularly a horizontal screen usage mode, and the second operation mode is particularly a vertical screen usage mode;
switching the operation mode of the electronic device from the first operation mode to the second operation mode particularly comprises:
obtaining a first included angle of the electronic device relative to a preset plane at the first instant and when the electronic device is in the horizontal screen usage mode, wherein the first included angle is within a first included angle scope corresponding to the horizontal screen usage mode;
obtaining a second included angle of the electronic device relative to the preset plane at the second instant later than the first instant; and
switching the electronic device from the horizontal screen usage mode to the vertical screen usage mode, when the first included angle is different from the second included angle and the second included angle is within a second included angle scope corresponding to the vertical screen usage mode.

18. The electronic device according to claim 17, wherein when the display screen is in the vertical screen usage mode, at least one first type icon corresponding to at least one first type application matched with the vertical screen usage mode is displayed on the first display area in the vertical screen usage mode of the display screen.

19. The electronic device according to claim 17, wherein when the display screen is in the horizontal screen usage mode, at least one second type icon corresponding to at least one second type application matched with the horizontal screen usage mode is displayed on the first display area in the horizontal screen usage mode of the display screen.

20. The electronic device according to claim 16, wherein when the electronic device is in a multi-modality electronic device pattern, the electronic device has a first body and a second body which are relatively rotatably connected via a shaft, a second face of the first body is provided with the display screen, a third face of the second body is provided with an input apparatus, the first operation mode is particularly one of a stand mode, a notebook mode, a tent mode and a tablet mode;
the second operation mode is particularly one of the stand mode, the notebook mode, the tent mode and the tablet mode, the second operation mode being different from the first operation mode;
switching the operation mode of the electronic device from the first operation mode to the second operation mode particularly comprises:
obtaining a third included angle between the first body and the second body at the first instant and when the first operation mode is one of the stand mode, the notebook mode, the tent mode and the tablet mode owned by the electronic device, in which the third included angle is within a third included angle scope corresponding to the first operation mode;
obtaining a fourth included angle between the first body and the second body at the second instant later than the first instant; and
switching the electronic device from the first operation mode to another operation mode which is the second operation mode, when the fourth included angle is different from the third included angle and the fourth included angle is within a fourth included angle scope corresponding to another mode of the stand mode, the notebook mode, the tent mode and the tablet mode.

21. An electronic device, the electronic device having a display unit and further comprising:
an obtaining module, configured for obtaining first operation information for the electronic device;
an operation module, configured for displaying a side column by the display unit according to the first operation information, the side column including at least a first part and a second part; wherein the first part is used for prompting a current usage mode of the electronic device to a user, and the second part comprises at least one interactive object.

22. The electronic device according to claim 21, wherein the obtaining module is particularly configured for obtaining the first operation information for changing the usage mode of the electronic device; or obtaining the first operation information indicating that a specific key of the electronic device is pressed; or obtaining the first operation information indicating sliding in the display unit.

23. The electronic device according to claim 22, wherein when the first operation information indicating sliding in the display unit is obtained, the operation module is particularly configured for determining a first operation track corresponding to the first operation information; and controlling an edge of the side column to be unfolded along a movement direction of the first operation track in the display unit.

24. The electronic device according to claim 21, wherein the obtaining module is further configured for obtaining second operation information for a first interactive object;
the operation module is further configured for displaying a first display window corresponding to the first interactive object by the display unit, and forbidding displaying the side column.

25. The electronic device according to claim 21, wherein the obtaining module is further configured for obtaining third operation information for the electronic device;
the operation module is further configured for forbidding displaying the side column according to the third operation information;
when the third operation information is the operation information indicating sliding in the display unit, the operation module is particularly configured for determining a third operation track corresponding to the third operation information, and controlling an edge of the side column to be folded along a movement direction of the third operation track in the display unit.
